(19) United States
(12) Patent Application Publication
(10) Pub. No.: US 2003/0101237 A1
(43) Pub. Date: May 29, 2003

(54) Image forming program and image forming apparatus

(76) Inventors: Shinichi Ban, Sakai-Shi (JP); Noriyuki Okisu, Osakasayama-Shi (JP); Nobuo Hashimoto, Ashiya-Shi (JP); Shoichi Minato, Sakai-Shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/304,302

(22) Filed: Nov. 26, 2002

(30) Foreign Application Priority Data
Nov. 29, 2001 (JP) 2001-364753
Dec. 21, 2001 (JP) 2001-388719
Dec. 25, 2001 (JP) 2001-390879
Dec. 26, 2001 (JP) 2001-393024
Dec. 26, 2001 (JP) 2001-393150

(51) Int. Cl. G06F 15/16

(52) U.S. Cl. 709/218

(57) ABSTRACT

Based on image data including a whole image 91, a specified region 91a defining a part of the whole image 91, and character data 91b corresponding to the part of the whole image within the specified region 91a, an image is displayed or printed that has the character data 92b arranged near to an extracted image 92a obtained by extracting from the whole image 91 the part thereof within the specified region 91a.

This application is based on the following Japanese Patent Applications, the contents of which are hereby incorporated by reference:

Japanese Patent Application No. 2001-364753 filed on Nov. 29, 2001

Japanese Patent Application No. 2001-388719 filed on Dec. 21, 2001

Japanese Patent Application No. 2001-390879 filed on Dec. 25, 2001

Japanese Patent Application No. 2001-393024 filed on Dec. 26, 2001

Japanese Patent Application No. 2001-393150 filed on Dec. 26, 2001

### BACKGROUND OF THE INVENTION

1. Field of the Invention

The present invention relates to an image forming program and an image forming apparatus for forming an image on a computer. More particularly, the present invention relates to an image forming program and an image forming apparatus that permit simultaneous formation of an image and character data.

2. Description of the Prior Art

In recent years, as digital cameras become widespread, the use of image databases for organizing photographed images has been increasing. Such image databases allow the retrieval and viewing of images by means of an image forming program installed on a computer. The organization of images is achieved through the entry of comments relating to individual images and the simultaneous viewing of an image along with the comments relating thereto.

On the other hand, there have been established many sites on the Web (hereinafter referred to as “Web photo sites”) which have image data stored on a server accessible over the Internet to allow the viewing of images from anywhere. Here, an image forming program as mentioned above is run on a server, so that each user can operate an image database by accessing a Web photo site.

Such Web photo sites allow, as well as the viewing of images, the transmission of comments thereon by the general public. Thus, when a user views images, they are displayed on a display screen along with the comments on each of them from a plurality of people.

However, the conventional image forming program described above is convenient in that it allows comments to be added to each image, but is inconvenient in that it does not allow, when many comments are added to one image, clear distinction of which comments relate to which parts of the image. This diminishes the operability of the image forming program when, for example, a user wishes to obtain information relating to a particular part of an image.

### SUMMARY OF THE INVENTION

An object of the present invention is to provide an image forming program that offers enhanced operability to a user.

To achieve the above object, according to one aspect of the present invention, an image forming program forms, based on image data including a whole image, a specified region defining a part of the whole image, and character data corresponding to the specified region of the whole image, an image having the character data arranged near to an extracted image extracting the specified region from the whole image.

According to another aspect of the present invention, an image forming program forms, based on image data including a whole image, a specified region defining a part of the whole image, and character data corresponding to the specified region of the whole image, an image composed of the character data and the whole image including the specified region. Here, the character data is displayed with attributes variable according to attributes with which the corresponding specified region is displayed.

According to another aspect of the present invention, an image forming program forms an image based on image data including a whole image, a specified region defining a part of the whole image, and character data corresponding to the specified region of the whole image. Here, for particular character data, a plurality of specified regions defined in a plurality of whole images are displayed with the particular character data displayed together.

According to another aspect of the present invention, an image forming program forms, based on image data including a whole image, a specified region defining a part of the whole image, and character data corresponding to the specified region of the whole image, an image composed of the whole image and the character data. Here, an image extracting function is provided so that, when the character data is selected, an extracted image extracting the specified region from the whole image corresponding to the character data is displayed with enlargement.

According to another aspect of the present invention, an image processing apparatus is provided with an image forming unit for forming, based on image data including a whole image, a specified region defining a part of the whole image, and character data corresponding to the specified region of the whole image, an image having the character data arranged near to an extracted image extracting the specified region from the whole image.

According to another aspect of the present invention, an image processing apparatus is provided with an image forming unit for forming, based on image data including a whole image, a specified region defining a part of the whole image, and character data corresponding to the specified region of the whole image, an image composed of the character data and the whole image including the specified region. Here, the character data is displayed with attributes variable according to attributes with which the corresponding specified region is displayed.

According to another aspect of the present invention, an image processing apparatus is provided with an image forming unit for forming an image based on image data including a whole image, a specified region defining a part of the whole image, and character data corresponding to the specified region of the whole image. Here, for particular character data, a plurality of specified regions defined in a plurality of whole images are displayed with the particular character data displayed together.

According to another aspect of the present invention, an image processing apparatus is provided with an image forming unit for forming, based on image data including a whole image, a specified region defining a part of the whole image, and character data corresponding to the specified region of the whole image, an image composed of the whole image and the character data. Here, an image extracting function is provided so that, when the character data is selected, an extracted image extracting the specified region from the whole image corresponding to the character data is displayed with enlargement.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a flow chart showing the image forming program of a first embodiment of the invention;

FIG. 2 is a flow chart showing the folder selection procedure of the image forming program of the first embodiment;

FIG. 3 is a flow chart showing the image overview procedure of the image forming program of the first embodiment;

FIG. 4 is a flow chart showing the comment bulletin board procedure of the image forming program of the first embodiment;

FIG. 5 is a flow chart showing the printout setting procedure of the image forming program of the first embodiment;

FIG. 6 is a flow chart showing the preview display procedure of the image forming program of the first embodiment;

FIG. 7 is a diagram showing the log-in screen of the image forming program of the first embodiment;

FIG. 8 is a diagram showing the user registration screen of the image forming program of the first embodiment;

FIG. 9 is a diagram showing the folder selection screen of the image forming program of the first embodiment;

FIG. 10 is a diagram showing the image overview screen of the image forming program of the first embodiment;

FIG. 11 is a diagram showing the file designation screen of the image forming program of the first embodiment;

FIG. 12 is a diagram showing the comment bulletin board screen of the image forming program of the first embodiment;

FIG. 13 is a diagram showing the printout setting screen of the image forming program of the first embodiment;

FIG. 14 is a diagram showing the printout preview screen of the image forming program of the first embodiment;

FIG. 15 is a flow chart showing the printout setting procedure of the image forming program of a second embodiment of the invention;

FIG. 16 is a diagram showing the printout setting screen of the image forming program of the second embodiment;

FIG. 17 is a diagram showing the preview display screen of the image forming program of the second embodiment;

FIG. 18 is a diagram showing another example of the preview display screen of the image forming program of the second embodiment;

FIG. 19 is a diagram showing another example of the preview display screen of the image forming program of the second embodiment;

FIG. 20 is a diagram showing another example of the preview display screen of the image forming program of the second embodiment;

FIG. 21 is a diagram showing the preview display screen of the image forming program of a third embodiment of the invention;

FIG. 22 is a flow chart showing the image overview procedure of the image forming program of a fourth embodiment of the invention;

FIG. 23 is a flow chart showing the printout setting procedure of the image forming program of the fourth embodiment;

FIG. 24 is a diagram showing the image overview screen of the image forming program of the fourth embodiment;

FIG. 25 is a diagram showing the printout setting screen of the image forming program of the fourth embodiment;

FIG. 26 is a diagram showing the preview display screen of the image forming program of the fourth embodiment;

FIG. 27 is a flow chart showing the comment bulletin board procedure of the image forming program of a fifth embodiment of the invention;

FIG. 28 is a diagram showing the comment bulletin board screen of the image forming program of the fifth embodiment, with an extracted image displayed;

FIG. 29 is a diagram showing the comment bulletin board screen of the image forming program of the fifth embodiment, with an extracted image enlarged;

FIG. 30 is a diagram showing the comment bulletin board screen of the image forming program of the fifth embodiment, with an extracted image reduced;

FIG. 31 is a block diagram showing the configuration of the digital camera of a sixth embodiment of the invention;

FIG. 32 is a diagram showing how image data is stored in the digital camera of the sixth embodiment;

FIG. 33 is a diagram schematically showing the configuration of the message processing system of a seventh embodiment of the invention;

FIG. 34 is a diagram schematically showing the hardware configuration of the image server of the message processing system of the seventh embodiment;

FIG. 35 is a diagram showing the state transition, in the administration operation, of the image server of the message processing system of the seventh embodiment;

FIG. 36 is a flow chart showing the administration operation of the message processing system of the seventh embodiment;

FIG. 37 is a diagram showing the initial screen in the administration operation of the message processing system of the seventh embodiment;

FIG. 38 is a diagram showing the in-box setting screen of the message processing system of the seventh embodiment;

FIG. 39 is a flow chart showing the in-box setting procedure of the message processing system of the seventh embodiment;

FIG. 40 is a diagram showing the in-box addition screen of the message processing system of the seventh embodiment;

FIG. 41 is a diagram showing the in-box modifying screen of the message processing system of the seventh embodiment;

FIG. 42 is a diagram showing the image storage folder setting screen of the message processing system of the seventh embodiment;

FIG. 43 is a flow chart showing the image storage folder setting procedure of the message processing system of the seventh embodiment;

FIG. 44 is a diagram showing the image storage folder addition screen of the message processing system of the seventh embodiment;

FIG. 45 is a diagram showing the image storage folder modifying screen of the message processing system of the seventh embodiment;

FIG. 46 is a diagram showing the image correction setting screen of the message processing system of the seventh embodiment;

FIG. 47 is a flow chart showing the image correction setting procedure of the message processing system of the seventh embodiment;

FIG. 48 is a diagram showing the image correction processing type addition screen of the message processing system of the seventh embodiment;

FIG. 49 is a diagram showing the image correction processing type modification screen of the message processing system of the seventh embodiment;

FIG. 50 is a diagram showing the relationship among themes, in-box mail addresses, storage folders, etc. in the message processing system of the seventh embodiment;

FIG. 51 is a flow chart showing the operation of the digital camera and the server when an image is uploaded in the message processing system of the seventh embodiment;

FIG. 52 is a diagram showing the digital camera of the message processing system of the seventh embodiment, as seen from behind;

FIG. 53 is a flow chart showing the image viewing procedure of the message processing system of the seventh embodiment;

FIG. 54 id a diagram showing an example of display using an “exhibition report” display template in the message processing system of the seventh embodiment;

FIG. 55 is a flow chart showing the image display procedure, using a display template, of the message processing system of the seventh embodiment;

FIG. 56 is a diagram showing the unit region of the message processing system of the seventh embodiment, before enlarged display of an image;

FIG. 57 is a diagram showing the unit region of the message processing system of the seventh embodiment, after enlarged display of an image;

FIG. 58 is a diagram showing another display template (in a thumbnail format) of the message processing system of the seventh embodiment; and

FIG. 59 is a diagram showing still another display template (in a slide show format) of the message processing system of the seventh embodiment.

### DESCRIPTION OF THE PREFERRED EMBODIMENTS

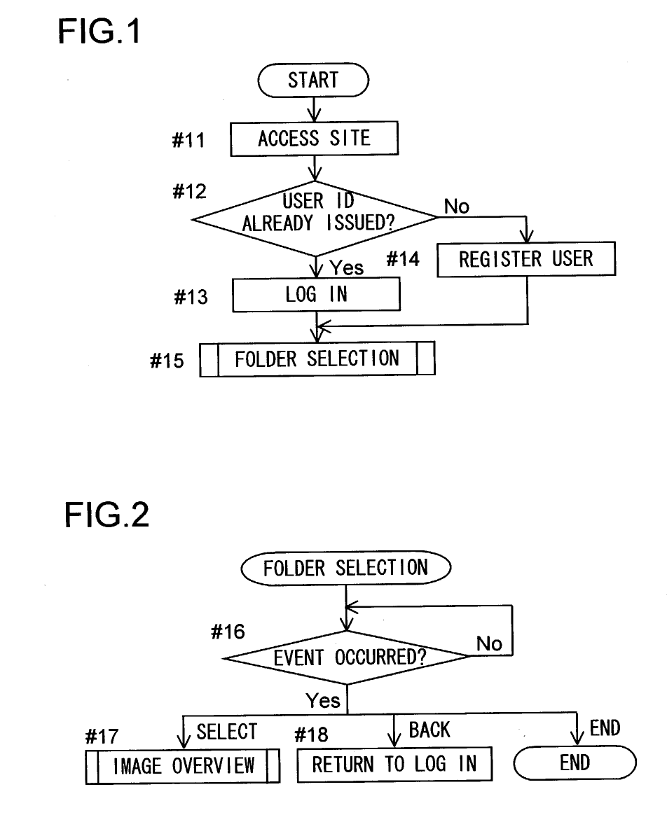

Hereinafter, embodiments of the present invention will be described with reference to the drawings. FIGS. 1 to 6 are flow charts showing the operation of the image forming program of a first embodiment of the invention. The image forming program of this embodiment is stored and executed on an Internet server. A user can operate the image forming program by accessing over the Internet the Web photo site established on the server.

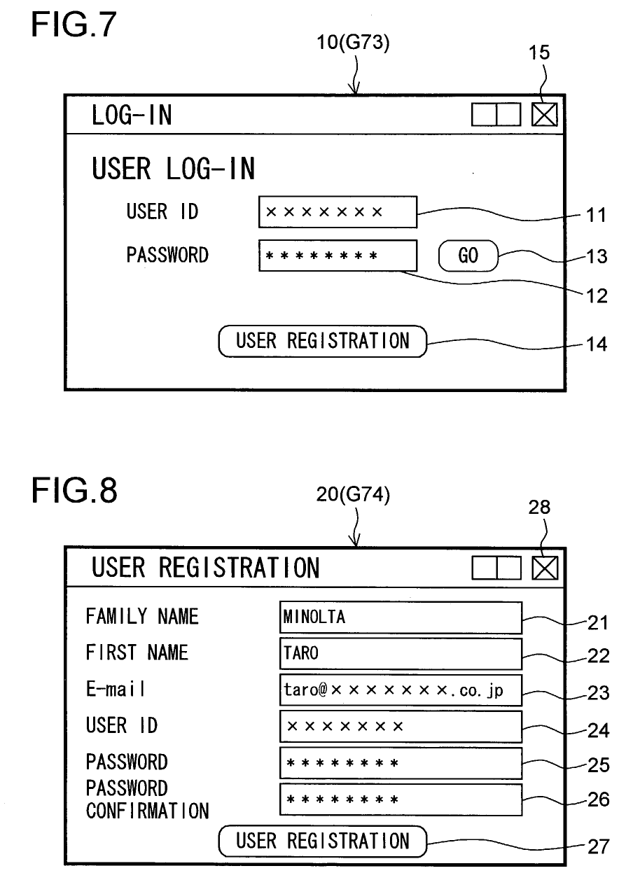

First, using any Web browser, the user accesses the Web photo site (step #11). This starts the image forming program, and, in step #12, the log-in screen 10 shown in FIG. 7 is displayed on the monitor screen.

If the user has already acquired a user ID, the user can log in by entering the user ID and a password in the text boxes 11 and 12 and then selecting the GO button 13 (step #13). The program then proceeds to step #15, where it calls the “folder selection” procedure shown in FIG. 2. If the user selects the end button 15, the image forming program terminates.

If the user has not yet acquired a user ID, the user selects the user registration button 14. The program then proceeds to step #14, where it displays the user registration screen 20 shown in FIG. 8 on the monitor screen. The user enters his or her family name, first name, and mail address in the text boxes 21, 22, and 23, respectively.

The user further enters a user ID and a password he or she desires in the text boxes 24 and 25, respectively, and then enters the password again in the text box 26 to confirm it. Thereafter, the user can log in by selecting the user registration button 27. The program then proceeds to step #15, where it calls the “folder selection” procedure shown in FIG. 2. If the user selects the end button 28, the image forming program terminates.

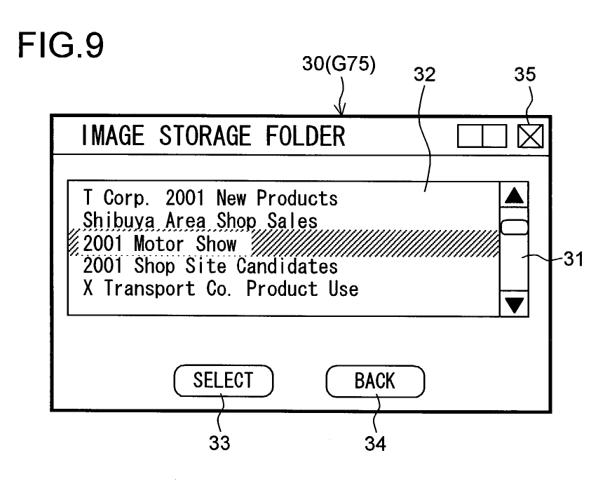

In the “folder selection” procedure, the folder selection screen 30 shown in FIG. 9 is displayed. In the folder selection screen 30, there is shown a list box 32, in which is shown a list of folders in which image files are stored. By manipulating the scroll bar 31, the user can scroll and glance at the folders.

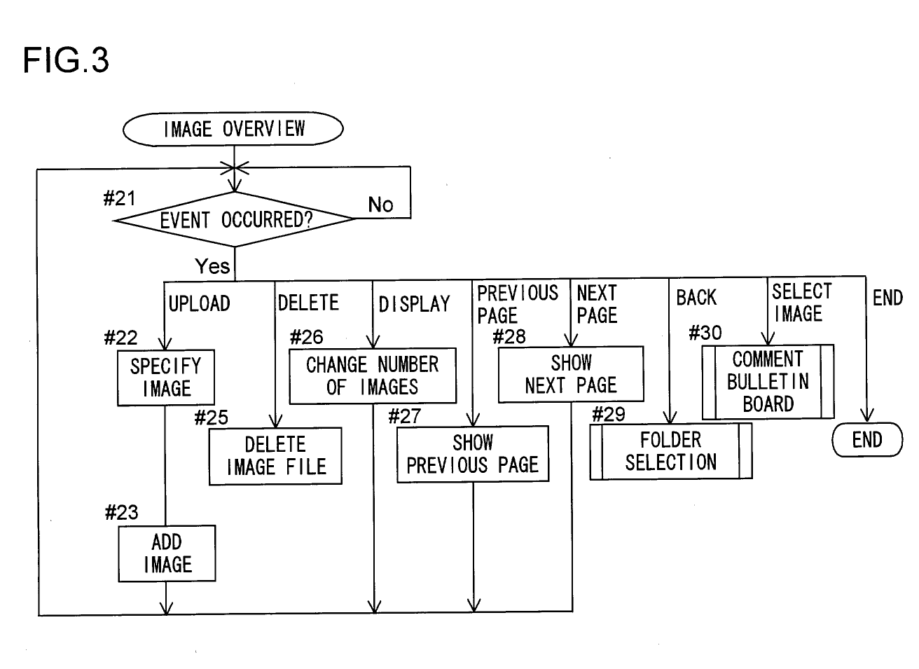

In step #16, whether an event has occurred or not is monitored so that, whenever an event occurs, the corresponding procedure is executed. The user, by manipulating the scroll bar 31, scrolls the folder list to highlight a folder he or she desires and then selects the select button 33. The program then proceeds to step #17, where it calls the “image overview” procedure shown in FIG. 3. If the user selects the back button 34, the program proceeds to step #18 to return to the log-in screen 10 shown in FIG. 7. If the user selects the end button 35, the image forming program terminates.

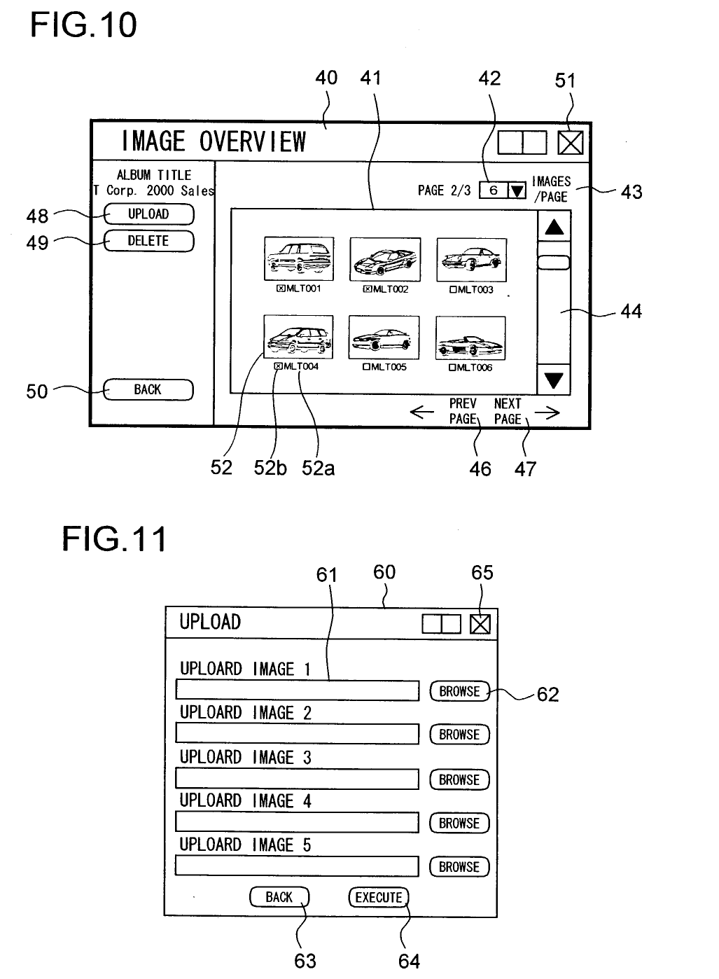

In the “image overview” procedure, the image overview screen 40 shown in FIG. 10 is displayed, in which is shown a list of image files existing in the selected folder. In the image overview screen 40, there is shown a list box 41, in which are shown reduced versions of the images of image files stored in a database created on the Internet server. The user, by manipulating the scroll bar 44, can scroll and glance at the images.

In FIG. 3, in step #21, whether an event has occurred or not is monitored so that, whenever an event occurs, the corresponding procedure is executed. When the user selects the upload button 48, the program proceeds to step #22, where it displays the file designation screen 60 shown in FIG. 11. In the file designation screen 60, the user can specify target image files.

In the file designation screen 60, there are shown a plurality of text boxes 61 in which to enter the file names of image files that the user wants to upload to the Internet server. The user enters in the text boxes 61 the file names of image files stored in a local folder. Alternatively, the user can use the browse buttons 62 to search a local folder for image files and copy their names into the text boxes 61.

When the user, after entering file names, selects the execute button 64, the files specified in step #23 are uploaded so as to be added in the Web photo site. The program then returns to step #21 to display the image overview screen 40 shown in FIG. 10. If, in step #22 or #23, the user selects the back button 63, the program, without performing uploading, returns to step #21, where it displays the image overview screen 40. If the user selects the end button 65, the image forming program terminates.

In the event monitoring state with the image overview screen 40 displayed (step #21), when the user selects the delete button 49, the program proceeds to step #25, where it deletes image files. The images 52 shown in the list box 41 are each accompanied by their respective file name 52a and a check box 52b. When the user selects the delete button 49, those images whose check boxes 52b have previously been checked are deleted from the Web photo site.

In the event monitoring state with the image overview screen 40 displayed (step #21), when the user selects the display button 43, the program proceeds to step #26. In step #26, the number of images shown in a single screen is changed to the number specified in the combo box 42. When the user selects the previous page button 46 or the next page button 47, the program proceeds to step #27 or #28, respectively, where it shows the screen of the previous or next page. If the user selects the back button 50, the program calls the “folder selection” procedure shown in FIG. 2 described earlier.

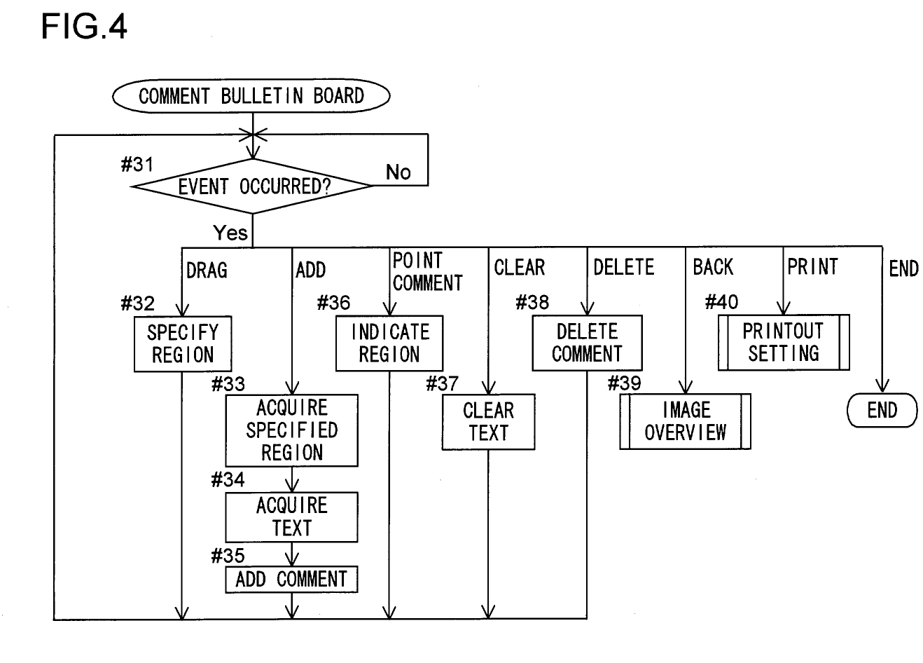

In the event monitoring state with the image overview screen 40 displayed (step #21), when the user selects one of the images 52 shown in the list box 41, the program proceeds to step #30, where it calls the “comment bulletin board” procedure shown in FIG. 4. Selection among the images 52 is achieved, for example, with a single or double click of a mouse. If the user selects the end button 51, the image forming program terminates.

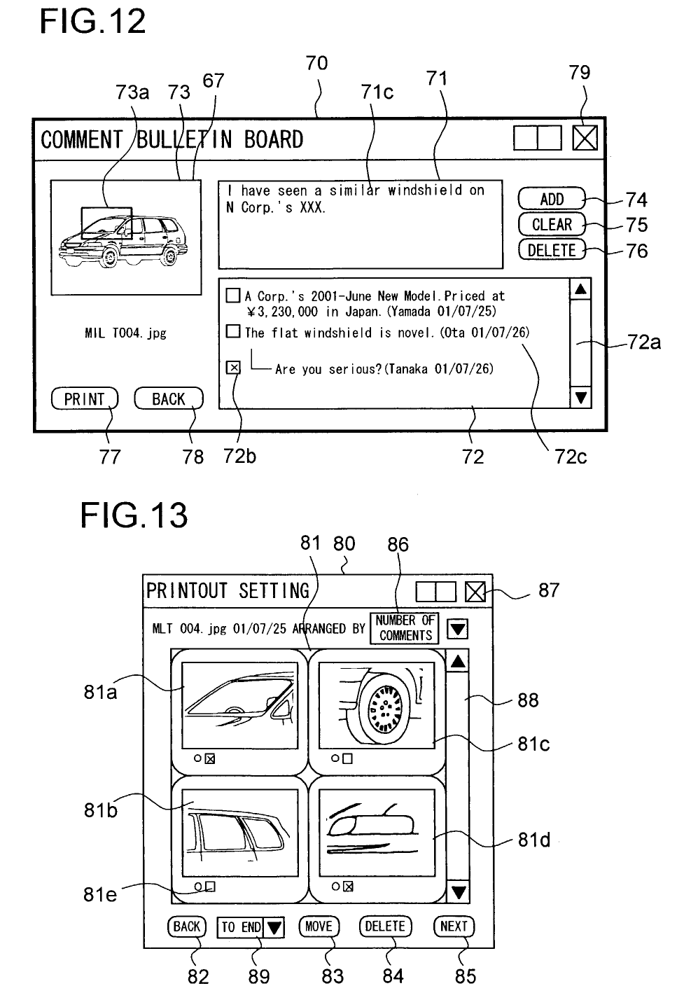

In the “comment bulletin board” procedure, the comment bulletin board screen 70 shown in FIG. 12 is displayed. Since the Web photo site is established on the Internet server, anyone can access it to view image files shared by the public. As users transmit comments on images displayed on their respective monitor screen to the server, a database of such comments is made open to the public in the form of a bulletin board on the Web photo site.

In the comment bulletin board screen 70, there are shown a whole image 73 of the selected image file, a text box 71 in which to enter a comment, and a list box 72 in which are shown a list of comments made open to the public. By manipulating the scroll bar 72a, the user can scroll the list box 72 and glance at the comments.

In FIG. 4, in step #31, whether an event has occurred or not is monitored so that, whenever an event occurs, the corresponding procedure is executed. When the user specifies part of the whole image 73 with a drag of a pointing device such as a mouse, the program proceeds to step #32. In step #32, if a specified region 73a is already indicated, it is cleared, and the newly specified part of the whole image 73 is indicated as a specified region 73a within the whole image 73. The program then returns to step #31, going back into the event monitoring state.

Thus, an image can be viewed not only as a whole but for each of regions 73a so specified within the image, and accordingly comments can be managed for each of those specified regions 73a. In this embodiment, a region is specified by specifying two diagonal vertices of a rectangular region with a drag of a mouse or the like. It is also possible, however, to specify a region by specifying every vertex of a polygonal region.

In the event monitoring state (step #31), when the user selects the add button 74, the program proceeds to step #33. In step #33, the range of the specified region 73a indicated is acquired and then, in step #34, the comment consisting of text (character data) entered in the text box 71 is acquired.

Then, in step #35, the specified region 73a and the comment are incorporated into the image data and stored on the server, and the comment is added on the bulletin board as a comment related to the specified region 73a. Thereafter, the program returns to step #31, going back into the event monitoring state. It is to be noted that, if no specified region 73a is indicated, the comment is added on the bulletin board as a comment relating to the whole image 73.

In the event monitoring state (step #31), when the user points a comment in the list box 72 with a click of a mouse or the like, the program proceeds to step #36. In step #36, the specified region 73a corresponding to the pointed comment is indicated, and then the program returns to step #31, going back into the event monitoring state. When the user, after this operation, selects the add button 74, a comment is processed as a comment relating to the specified region 73a indicated. It is to be noted that, if the pointed comment relates to the whole image 73, no specified region 73a is indicated.

The comments shown in the list box 72 are each headed with a check box 72b. When the user checks the check box 72b of a comment there and then selects the add button 74, the comment he or she has entered is made open to public on the bulletin board as a reply to the checked comment.

In the event monitoring state (step #31), when the user selects the clear button 75, the program proceeds to step #37, where it clears the data entered in the text box 71. When the user selects the delete button 76, the program proceeds to step #38, where it deletes from the bulletin board the user's own comment of which the check box 72b is checked. Thereafter, the program returns to step #31, going back into the event monitoring state.

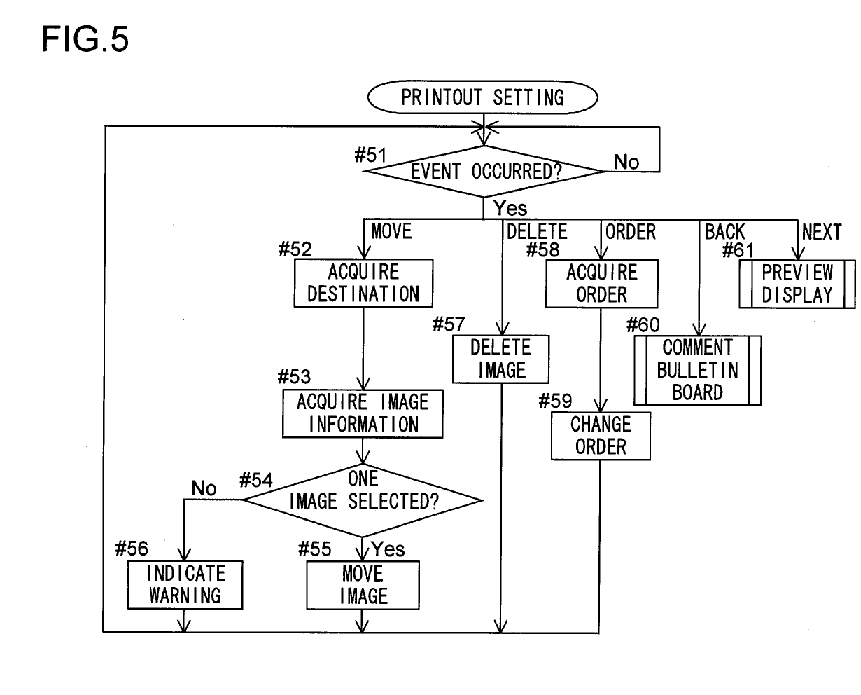

In the event monitoring state (step #31), when the user selects the back button 78, the program calls the “image overview” procedure shown in FIG. 3 described earlier. If the user selects the end button 79, the image forming program terminates. If the user selects the print button 77, the program proceeds to step #40, where it calls the “printout setting” procedure shown in FIG. 5.

In the “printout setting” procedure, the printout setting screen 80 shown in FIG. 13 is displayed. In the printout setting screen 80, there is shown a list box 81 in which is shown an overview of extracted images 81a, 81b, 81c, 81d, . . . obtained by extracting the image within each specified region 73a from the whole image (see FIG. 12). The user, by manipulating the scroll bar 88 of the list box 81, can scroll and glance at the extracted images 81a, 81b, 81c, 81d, . . . to decide on which of them to print.

In FIG. 5, in step #51, whether an event has occurred or not is monitored so that, whenever an event occurs, the corresponding procedure is executed. When the move button 83 is selected, then, in step #52, the destination specified in the combo box 89 is acquired.

The extracted images 81a, 81b, 81c, 81d, . . . are each accompanied by a check box 81e below. In step #53, the information on the extracted images of which the check box is checked is acquired. In step #54, whether only one extracted image is checked or two or more are checked is checked. If only one extracted image is checked, the program proceeds to step #55, where it moves the checked extracted image to the acquired destination. If two or more extracted images are checked, then, in step #56, the program shows a warning dialog. The program then returns to step #51, going back into the event monitoring state.

In the event monitoring state (step #51), when the user selects the delete button 84, the program proceeds to step #57. In step #57, the extracted images of which the check box 81e is checked (in FIG. 13, 81a and 81d) are hidden and excluded from the targets to be printed. The program then goes back into the event monitoring state.

In the event monitoring state (step #51), when the user selects in the combo box 86 the order in which to show the extracted images, the program proceeds to step #58, where it acquires the order specified in the combo box 86. In the combo box 86 are shown alternatives of the condition for rearrangement of the extracted images, such as the number of comments, the dates of the comments, etc, to permit the user to select a desired alternative. In step #59, the extracted images 81a, 81b, 81c, 81d, . . . are rearranged in the order acquired, and the program then goes back into the event monitoring state.

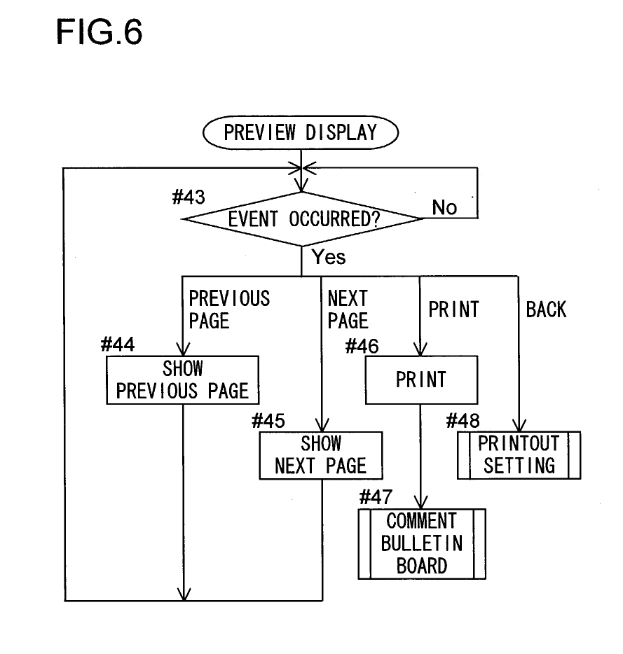

In the event monitoring state (step #51), when the user selects the back button 82, the program calls the “comment bulletin board” procedure shown in FIG. 4 described earlier. If the user selects the end button 87, the image forming program terminates. If the user selects the next button 85, the program calls the “preview display” procedure shown in FIG. 6.

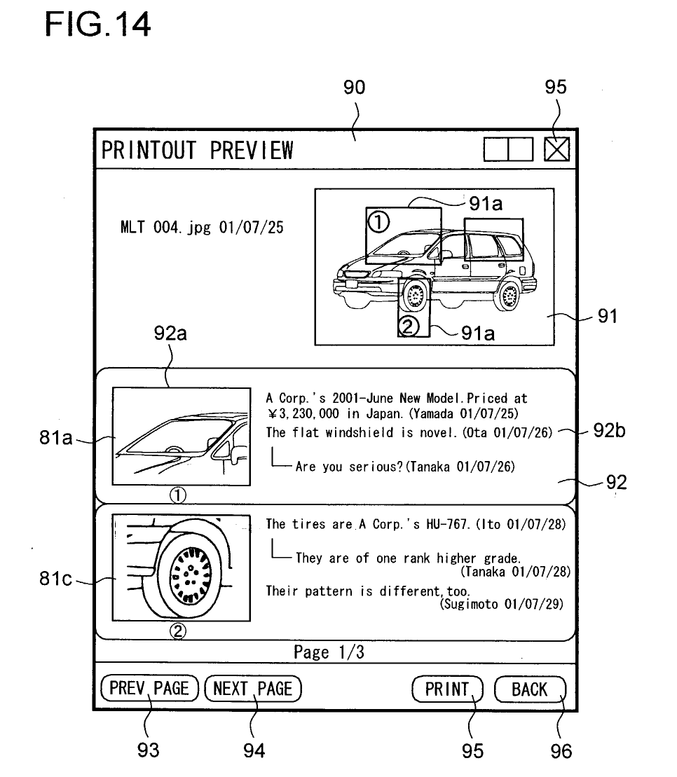

In the “preview display” procedure, the printout preview screen 90 shown in FIG. 14 is displayed. In the printout preview screen 90 is shown the precise layout of the image that is going to be printed. In an upper portion of the printout preview screen 90, a whole image 91 of the image file is shown. In the whole image 91, the specified regions 91a (corresponding to 73a in FIG. 12) that are recognized as the targets to be printed are indicated.

Below the whole image 91, there are shown display frames 92. Within each display frame 92, one of the extracted images 92a selected in the “printout setting” procedure and the comments 92b on the bulletin board that relate to that extracted image 92a are shown in the left-hand and right-hand portions, respectively, of the display frame 92. There are shown as many display frames 92 as the specified regions 91a recognized as the targets to be printed, and, if all the display frames 92 cannot be shown within a single page, they are shown in a plurality of pages. In this case, the whole image 91 may be shown in an upper portion of each of the second and following pages.

In FIG. 6, in step #43, whether an event has occurred or not is monitored so that, whenever an event occurs, the corresponding procedure is executed. When the user selects the previous page button 93 or the next page button 94, the program proceeds to step #44 or #45, respectively, where it shows the printout image of the previous or next page. The program then goes back to the event monitoring state.

In the event monitoring state (step #43), when the user selects the print button 95, the program proceeds to step #46, where it produces a printout of the same image that is shown in the printout preview screen 90. On completion of the printing, in step #47, the program calls the “comment bulletin board” procedure shown in FIG. 4 described earlier. If the user selects the back button 96, the program calls the “printout setting” procedure shown in FIG. 5 described earlier. If the user selects the end button 97, the image forming program terminates.

In this embodiment, it is possible to display and print extracted images 92a, obtained by extracting the images within specified regions 91a from the whole image 91, together with the comments 92b relating thereto arranged near the corresponding specified regions. This permits the user to easily grasp which comments relate to which regions of an image. This enhances operability. Moreover, printing permits the user to easily grasp the contents of the comments relating to a number of specified regions even in an environment where no computer is available. This offers greater convenience.

Here, the designation of specified regions 73a (see FIG. 12), the entry of comments, and related operations are handled in the “comment bulletin board” procedure (see FIG. 4). However, it is also possible to omit the “comment bulletin board” procedure and instead display or print, by the use of an image forming program similar to that of this embodiment, files of image data that have specified regions and comments already written therein.

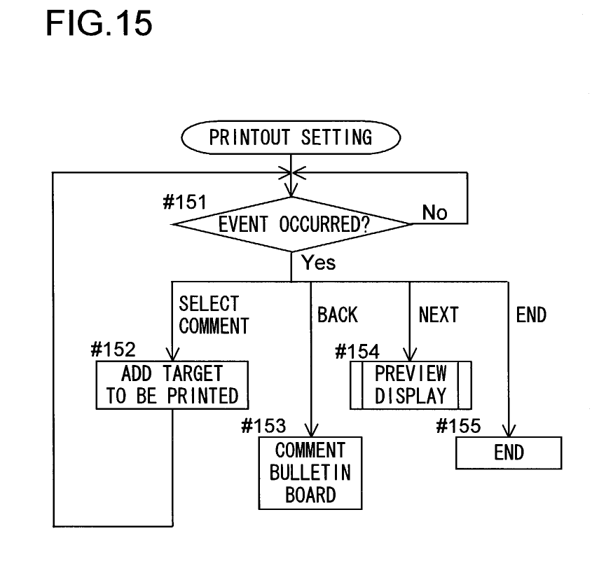

Next, a second embodiment of the invention will be described. In this embodiment, compared with the operation in the first embodiment shown in FIGS. 1 to 13 described above, the “printout setting” procedure is different from that shown in FIG. 5. In other respects, the operation in this embodiment is the same as that in the first embodiment, and therefore overlapping explanations will not be repeated., FIG. 15 is a flow chart showing the “printout setting” procedure.

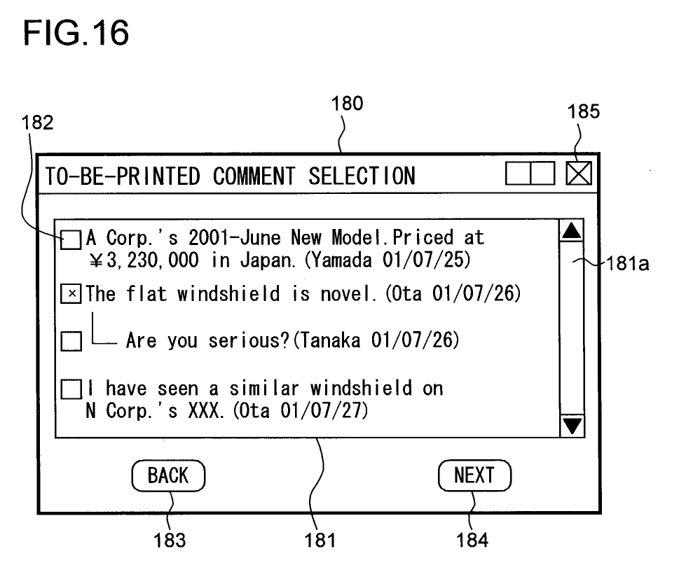

In the “printout setting” procedure, the to-be-printed comment selection screen 180 shown in FIG. 16 is displayed. In the to-be-printed comment selection screen 180, there is shown a list box 181, in which is shown an overview of comments. The user, by manipulating the scroll bar 181a, can scroll the list box 181 and glance at the comments to highlight the comments to be printed.

In FIG. 15, in step #151, whether an event has occurred or not is monitored so that, whenever an event occurs, the corresponding procedure is executed. When the user selects desired comments by checking the check box 182 with which each comment is headed, the program proceeds to step #152. In step #152, the selected comments are added as targets to be printed. The program then returns to step #151, going back to the event monitoring state.

Below the list box 181, there are arranged a back button 183 and a next button 184. In the event monitoring state (step #151), when the user selects the back button 183, then, in step #153, it calls the “comment bulletin board” procedure shown in FIG. 4 described earlier. If the user selects the end button 185, the image forming program terminates (step #155). If the user selects the next button 184, the program calls the “preview display” procedure shown in FIG. 6 described earlier.

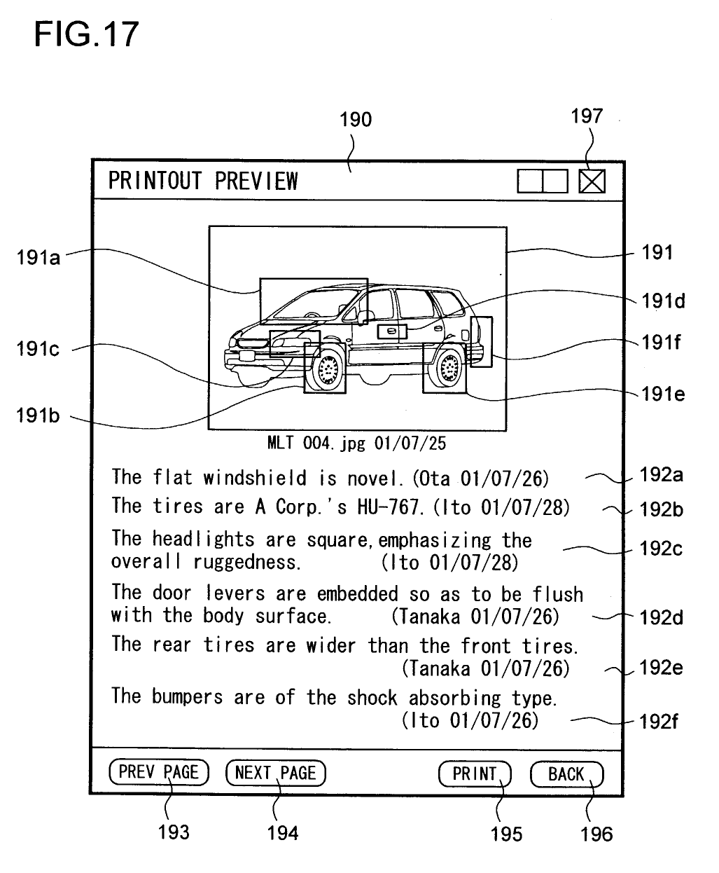

In the “preview display” procedure, the printout preview screen 190 shown in FIG. 17 is displayed. In the printout preview screen 190 is shown the precise layout of the image that is going to be printed on a printing medium. In an upper portion of the printout preview screen 190, a whole image 191 of the image file is shown.

Within the whole image 191, specified regions 191a to 191f (corresponding to 73a in FIG. 12) are indicated. The specified regions 191a to 191f are indicated with frame lines of different colors. For examples, black, blue, red, greed, yellow, pink, and violet are used, and are respectively allocated to the specified regions 191a to 191f.

Below the whole image 191 are shown the comments 192a to 192f selected in the “printout setting” process. The comments 192a to 192f relating to the specified regions 191a to 191f are displayed in the same colors as the frame lines of the corresponding specified regions 191a to 191f. For example, the comment 192a relating to the specified region 191a is indicated in black.

Likewise, the comments 192b, 192c, 192d, 192e, and 192f are displayed in blue, red, green, yellow, and pink, respectively. This permits the user to easily grasp which comments relate to which specified regions, and thereby enhances the operability of the Web photo site.

If the frame line of a specified region overlaps the pixels of the same color in the whole image, it is difficult to distinguish the specified region. To prevent this, when the difference between the average hue of the relevant pixels and the average hue of a frame line is smaller than a predetermined value, the next available color is allocated.

When there are more specified regions than available colors, the specified regions may be indicated in two or more pages. For example, when there are seven available colors and eight or more specified regions, seven of the specified regions are indicated in the first page, and the remaining one or more are indicated in the second page. This helps prevent erroneous association between specified regions and comments.

In this embodiment, the frame lines of the specified regions 191a to 191f and the comments 192a to 192f relating thereto are displayed or printed in the same colors, making the correspondence between specified regions and comments clearer. This permits the user to easily grasp which comments relate to which specified regions. This enhances operability. Moreover, printing permits the user to easily grasp the contents of the comments relating to a number of specified regions even in an environment where no computer is available. This offers greater convenience.

Specified regions and comments relating thereto may be displayed, not only in the same colors, but also with the same display attributes. In this way, it is possible to achieve the same effects as described above.

Examples of the display attributes of a specified region include the color used to convert the image within the specified region, the color, line type, and line thickness of the frame line of the specified region, the shape of the specified region, the color and content of a symbol, character, or figure added to the specified region, etc. Examples of the display attributes of a comment (character data) include the color of the character data, the color and content of a symbol, character, or figure added to the character data, etc. Between a specified region and a comment relating thereto, at lease one of the display attributes of the former is made identical with at least one of the display attributes of the latter.

For example, it is possible to convert the hue of the image within a specified region by mixing a predetermined color therewith, and display the corresponding comment in the color so added. For example, the image within a specified region is converted into a reddish image by mixing red therewith, and the corresponding comment is displayed in red. Alternatively, the image within a specified region may be converted into an image hatched with lines in the same color as the corresponding comment.

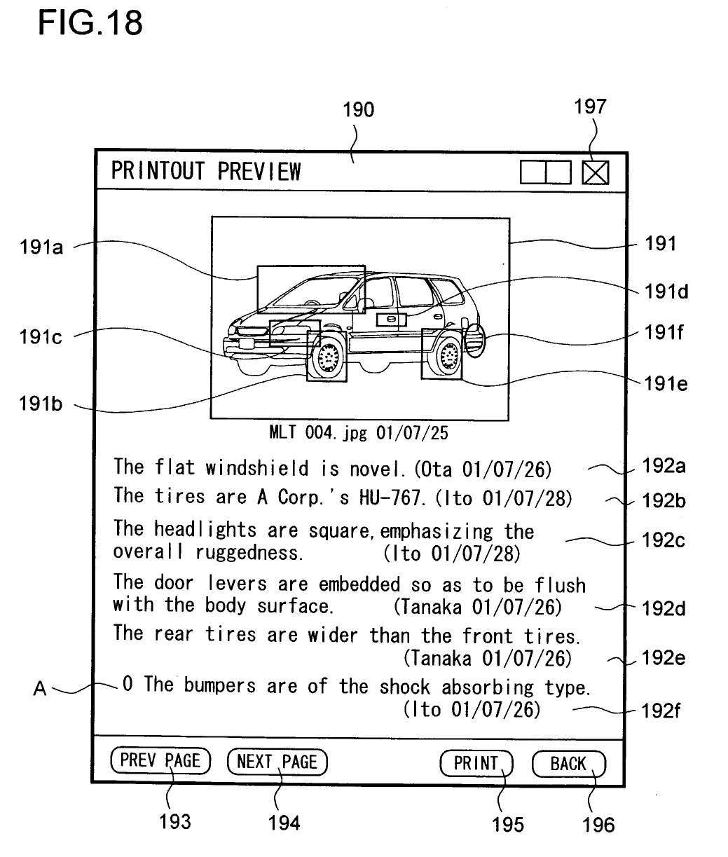

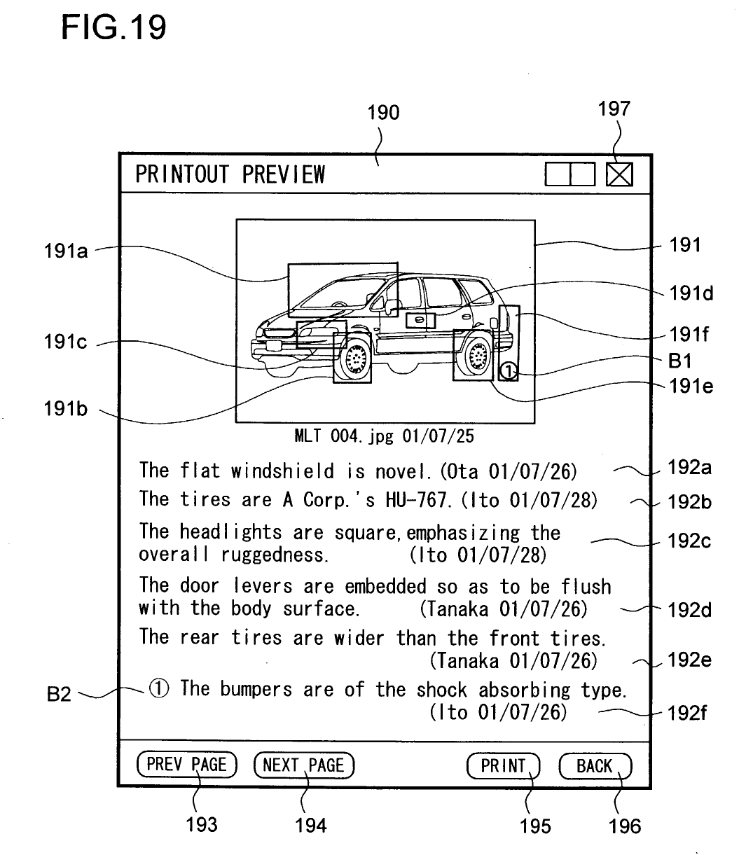

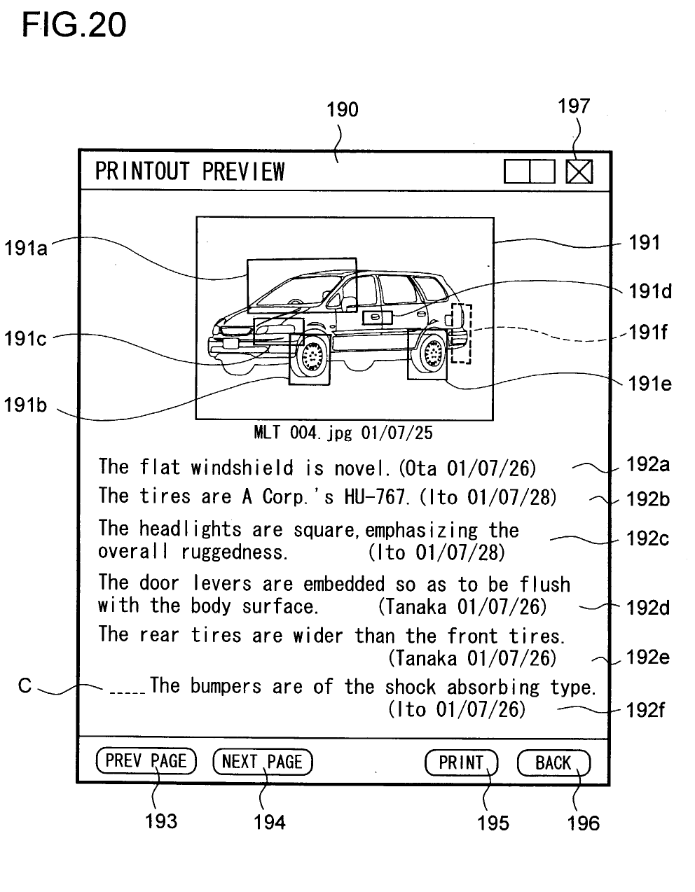

Moreover, as shown in FIG. 18, the shape of a specified region 191f may be made identical with the shape of the symbol A (here, elliptical) added at the head of the corresponding comment 192f. Alternatively, as shown in FIG. 19, the character B1 added to a specified region 191f may be made identical with the character B2 added at the head of the corresponding comment 192f. Alternatively, as shown in FIG. 20, the line type of the frame line of a specified region 191f may be made identical with the symbol C added at the head of the corresponding comment 192f. In any of these ways, it is possible to achieve the same effects as described above. It is to be noted that, in FIGS. 18 to 20, such elements as are found also in FIG. 17 are identified with the same reference numerals.

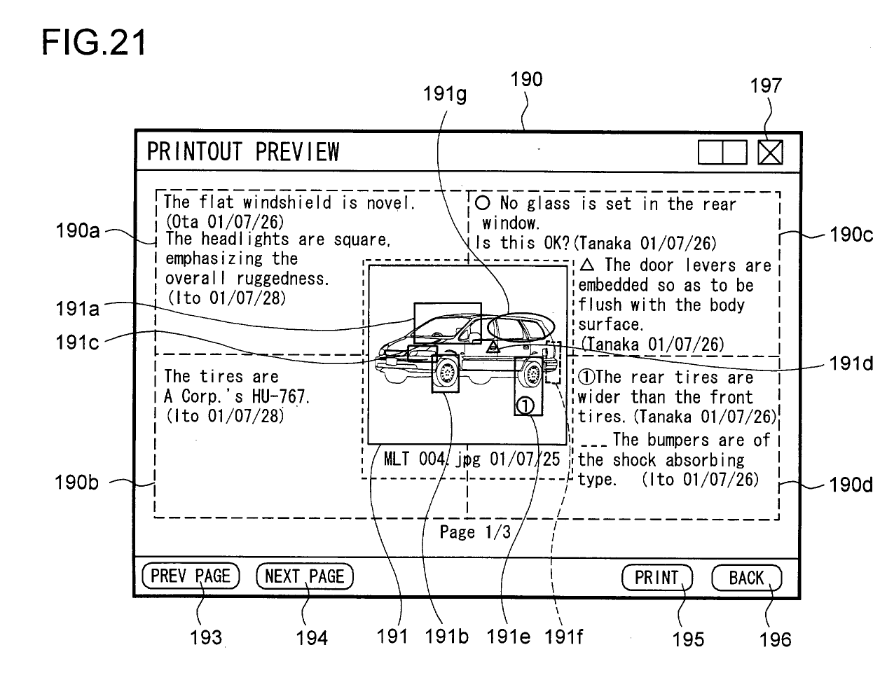

FIG. 21 shows the printout preview screen 190 of the image forming program of a third embodiment of the invention. Except for the printout preview screen 190, the operation in this embodiment is the same as that in the second embodiment, and, in FIG. 21, such elements as are found also in FIG. 17 are identified with the same reference numerals. In this embodiment, the printout preview screen 190 has the whole image 191 situated substantially in the center thereof. As in the second embodiment, the specified regions 191a to 191g within the whole image 191 and the corresponding comments are displayed with the same display attributes.

Around the whole image 191, there is arranged a comment display region, which is divided into an upper left-hand portion 190a, a lower left-hand portion 190b, an upper right-hand portion 191c, and a lower right-hand portion 191d. The comments relating to the specified regions 191a and 191c located in an upper left-hand portion of the whole image 191 are arranged in the upper left-hand portion 190a.

Likewise, the comments relating to the specified region 191b located in the lower left-hand portion of the whole image 191 is arranged in the lower left-hand portion 190b; the comments relating to the specified regions 191d and 191g located in an upper right-hand portion of the whole image 191 are arranged in the upper right-hand portion 190c; the comments relating to the specified regions 191e and 191f located in a lower right-hand portion of the whole image 191 are arranged in the lower right-hand portion 190d. This makes the correspondence between specified regions and comments even clearer than in the second embodiment. This further enhances operability.

In the second and third embodiments, the designation of specified regions 73a (see FIG. 12), the entry of comments, and related operations are handled in the “comment bulletin board” procedure (see FIG. 4). However, it is also possible to omit the “comment bulletin board” procedure and instead display or print, by the use of an image forming program similar to those of the second and third embodiment, files of image data that have specified regions and comments already written therein.

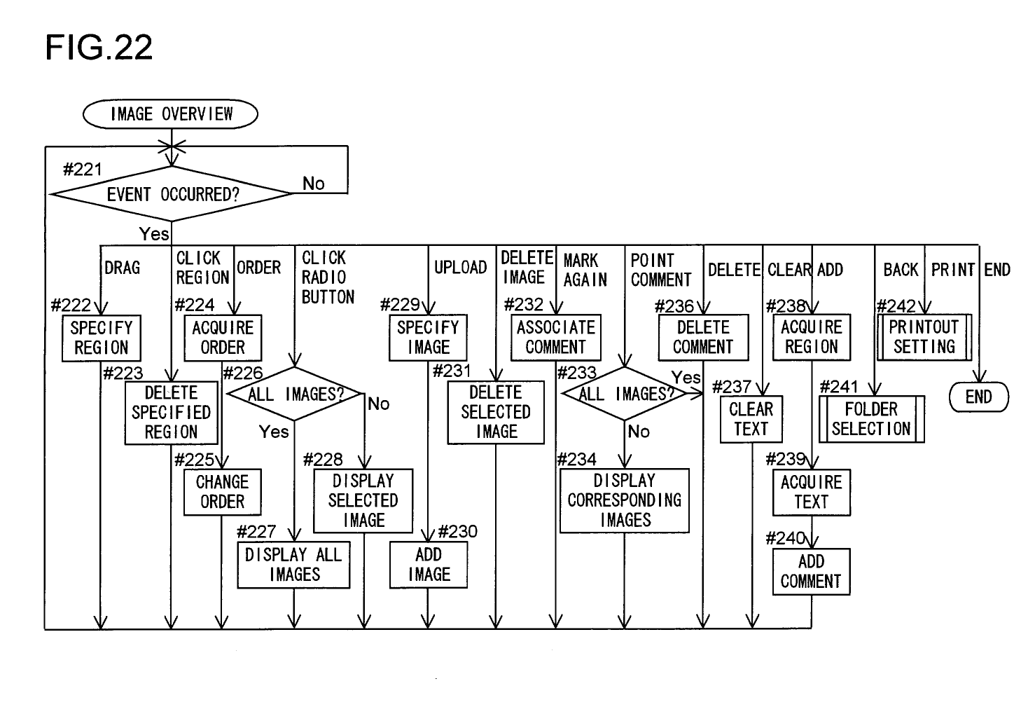

Next, a fourth embodiment of the invention will be described. In this embodiment, compared with the operation in the first embodiment shown in FIGS. 1 to 13 described earlier, the procedures from the “image overview” procedure through the “print setting” procedure are different from those shown in FIGS. 3 to 5. In other respects, the operation in this embodiment is the same as that in the first embodiment, and therefore overlapping explanations will not be repeated., FIG. 22 is a flow chart showing the “image overview” procedure.

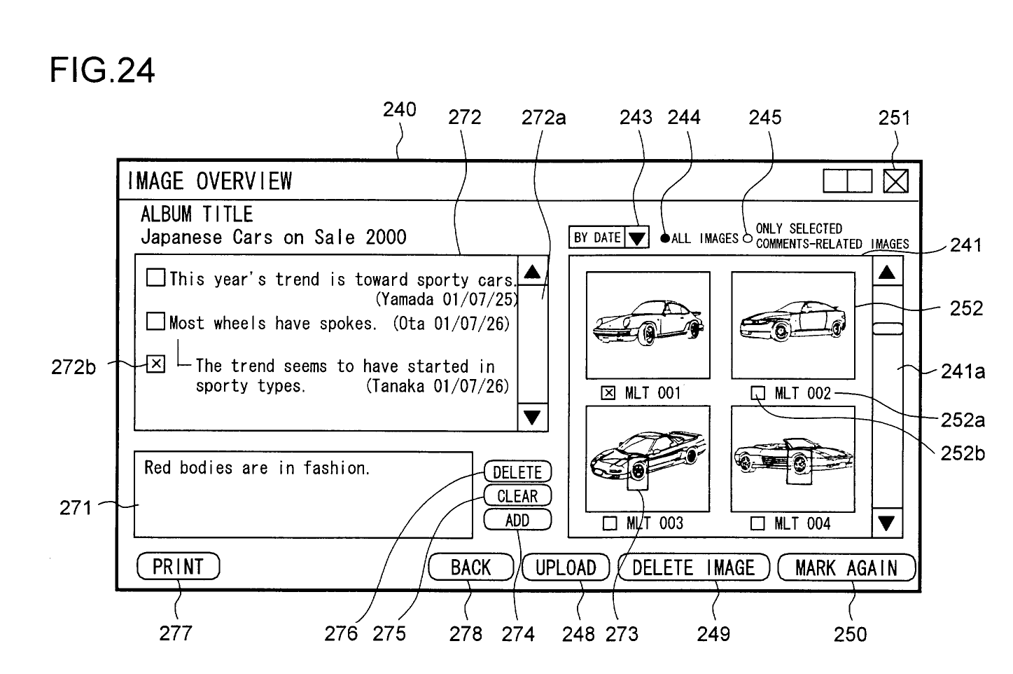

In the “image overview” procedure, the image overview screen 240 shown in FIG. 24 is displayed. Since the Web photo site is established on the Internet server, anyone can access it to view image files shared by the public. As users transmit comments on images displayed on their respective monitor screen to the server, a database of such comments is made open to the public in the form of a bulletin board on the Web photo site.

In the image overview screen 240, there are shown list boxes 241 and 272 and a text box 271. In the list box 241 is shown an overview of reduced versions of the whole images 252 of image files stored in the database created on the Internet server. By manipulating the scroll bar 241a, the user can scroll and glance at the whole images 252. The whole images 252 are each accompanied by their respective file name 252a and a check box 252b below.

In the list box 272 is shown a list of comments made open to the public on the bulletin board. By manipulating the scroll bar 272a, the user can scroll and glance at the comments. In the text box 271, the user enters a comment by operating a keyboard or the like.

In FIG. 22, in step #221, whether an event has occurred or not is monitored so that, whenever an event occurs, the corresponding procedure is executed. When the user specifies part of a whole image 252 with a drag of a pointing device such as a mouse, the program proceeds to step #222, where it indicates the specified part as a specified region 273 within the whole image 252.

The program then returns to step #221, going back into the event monitoring state. This sequence of operations may be repeated so that a plurality of specified regions 273 are designated in a plurality of whole images 252. This makes it possible to manage comments for each desired specified region 273.

A comment in the text box 271 is associated with a specified region 273 indicated in a whole image 252 when the user selects the add button 274. In the event monitoring state (step #221), when the user selects the add button 274, the program proceeds to step #238. In step #238, the range of the specified region 273 indicated is acquired, and then, in step #239, the comment consisting of text (character data) entered in the text box 271 is acquired.

Then, in step #240, the acquired comment is incorporated into the image data and stored on the server, and the comment is added as a comment related to the specified region 273 on the bulletin board. Thereafter, the program returns to step #221, going back into the event monitoring state. It is to be noted that, if no specified region 273 is indicated, the comment is added on the bulletin board as a comment relating to the whole image 252.

The comments shown in the list box 272 are each headed with a check box 272b. When the user checks the check box 272b of a comment there and then selects the add button 274, the comment he or she has entered is made open to public on the bulletin board as a reply to the checked comment.

In the event monitoring state (step #221), when the user clicks the right button with the cursor in a specified region 273, the program proceeds to step #223. In step #223, the program deletes that specified region 273 and clears the indication thereof from the display screen. The program then returns to step #221, going back into the event monitoring state.

In the event monitoring state (step #221), when the user manipulates the combo box 243 for specifying the order in which to show images, the program proceeds to step #224, where it acquires the specified order in which to show images, such as by the date, the file name, etc. Then, in step #225, the whole images 252 are rearranged in the order acquired, and the program then returns to step #221.

In the event monitoring state (step #221), when the user clicks one of the radio buttons 244 and 245 for selecting the mode in which to display images, the program proceeds to step #226. In step #226, whether the “all images” radio button 244 is clicked or not is checked. If the “all images” radio button 244 is clicked, then, in step #227, all the while images 252 in the selected folder are shown in the list box 241.

When the “only images associated with selected comments” radio button 245 is clicked, the program proceeds to step #228. In step #228, the whole images 252 associated with the comments of which the check boxes 272 are checked are shown in the list box 241. Thereafter, the program returns to step #221, going back into the event monitoring state.

When the user selects the upload button 248, the program proceeds to step #229, where the file designation screen 60 shown in FIG. 11 described earlier is displayed. When the user specifies image files here and uploads them in step #230, the image files are added on the Web photo site. The program then returns to step #221, where the image overview screen 240 shown in FIG. 24 is displayed.

In the event monitoring state (step #221), when the user selects the image delete button 249, the program proceeds to step #231. In step #23 1, the image files of which the check boxes 252b have previously been checked are deleted from the Web photo site.

In the event monitoring state (step #221), when the user selects the mark again button 250, the program proceeds to step #232. In step #232, the range of the specified region 273 that has been specified in the region designation step (see step #222) and is being currently indicated is acquired, and this specified region 273 is associated with the comments of which the check boxes 272b are checked. This makes it possible to associate a single comment with a plurality of specified regions 273. Thus, when this comment is selected next time, the corresponding specified portions 273 are indicated in the whole images 252 shown (see step #234).

In the event monitoring state (step #221), when the user points a comment in the list box 272 with a click of a mouse or the like, the check box 272b of that comment is checked, and the program proceeds to step #233. In step #233, which of the radio buttons 244 and 245 is selected is checked. If the “all images” radio button 244 is selected, the whole images 252 of all the image files in the specified folder remain shown in the list box 241, and the program returns to step #221.

If the “only images associated with selected comments” radio button 245 is selected, the program proceeds to step #234, where it shows only the whole images 252 including the specified regions 273 corresponding to the checked comments in the list box 241. The program then returns to step #221, going back into the event monitoring state.

In the event monitoring state (step #221), when the user selects the delete button 276, the program proceeds to step #236, where it deletes from the bulletin board the user's own comments of which the check boxes 272b are checked. If the user selects the clear button 275, the program proceeds to step #237, where it clears the data entered in the text box 271. Thereafter, the program returns to step #221, going back into the event monitoring state.

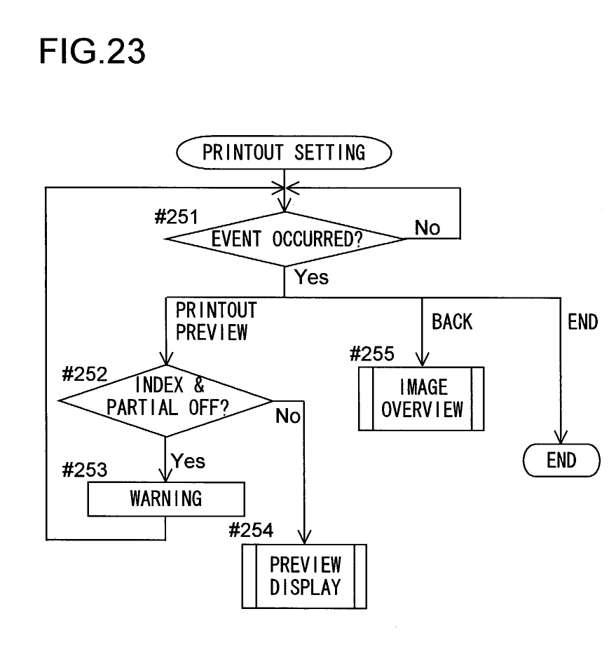

In the event monitoring state (step #221), when the user selects the print button 277, the program calls the “printout setting” procedure shown in FIG. 23 to print the specified regions 273 indicated and the comments relating thereto. If the user selects the back button 250, the program calls the “folder selection” procedure shown in Fig.2 described earlier. If the user selects the end button 251, the image forming program terminates.

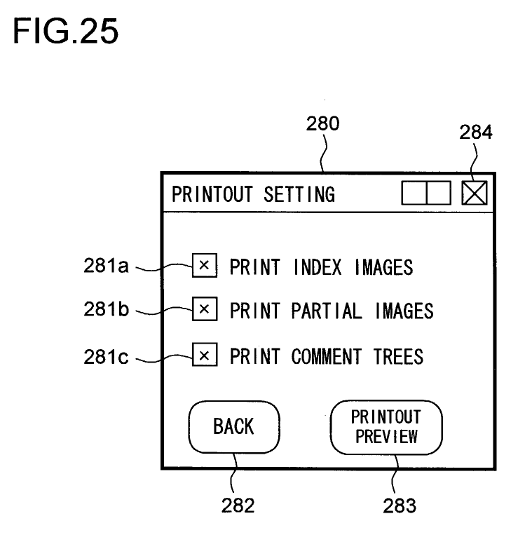

In the “printout setting” procedure, the printout setting screen 280 shown in FIG. 25 is displayed. In the printout setting screen 280, there are shown check boxes 281a, 281b, and 281c to be selected to “print index images,” “print partial images,” and “print comment trees,” respectively.

When the “print index images” check box 281a is selected, the whole images 252 including the specified regions 273 (see FIG. 24 for both) are printed. When the “print partial images” check box 281b is selected, enlarged versions of the images within the specified regions 273 are printed. When the “print comment trees” check box 281c is selected, the comments relating to the specified regions 273 and the comments relating to those comments are shown in the form of comment trees. For example, if a comment is a reply to another comment, the two are shown simultaneously, and, if this second comment is a reply to still another comment, all the three are shown simultaneously.

In FIG. 23, in step #251, whether an event has occurred or not is monitored so that, whenever an event occurs, the corresponding procedure is executed. If the printout preview button 293 is selected, then, in step #252, whether both of the check boxes 281a and 281b are off or not is checked. If both of the check boxes 281a and 281b are off, then, in step #253, a warning dialog is displayed, and then the program returns to step #251.

If at least one of the check boxes 281a and 281b is checked, the “preview display” procedure shown in FIG. 6 described earlier is called. If the user selects the back button 282, the “preview display” procedure shown in FIG. 22 described earlier is called. If the user selects the end button 284, the image forming program terminates.

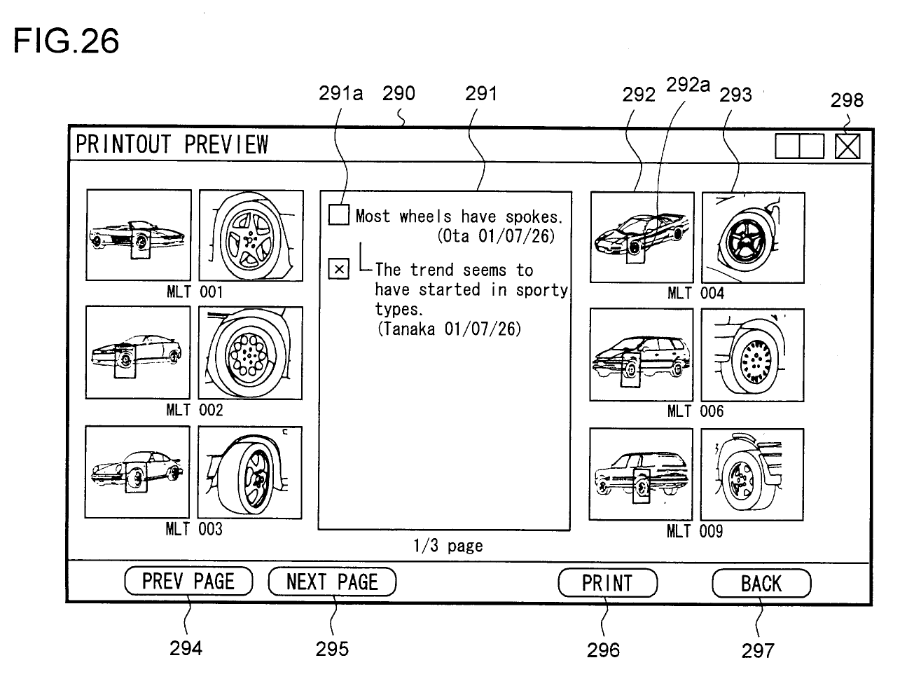

In the “preview display” procedure, the printout preview screen 290 shown in FIG. 26 is displayed. As in the first embodiment, in the printout preview screen 290 are shown a previous page button 294, a next page button 295, a print button 296, and a back button 297. As the user operates these buttons, the operations included in the “preview display” procedure described earlier are executed.

In the printout preview screen 290 is shown the precise layout of the image that is going to be printed. In a central portion of the printout preview screen 290, there is shown a list box 291, in which are shown the comments checked in the image overview screen 240 shown in FIG. 24 described earlier.

If the “print comment trees” check box 281c (see FIG. 25) has been selected, those comments are shown together with the comments relating thereto in the form of comment trees. Each comment is headed with a check indicator 291a to indicate the check with which it has been marked in the image overview screen 240.

On the left-hand and right-hand sides of the list box 291, there are shown whole images 292 including the specified regions 292a (corresponding to 273 in FIG. 24) corresponding to the checked comments. The frame line of each specified region 292a is indicated in a color of which the difference from the average hue of the pixels of the whole image 292 it overlaps is equal to or greater than a predetermined value.

By the side of each whole image 292 is shown an extracted image 293 obtained by extracting and enlarging the image within the corresponding specified region 292a. It is to be noted that, if, in FIG. 25 described above, the check box 281a has not been checked, no whole images 292 are shown and, if the check box 281b has not been checked, no extracted images 293 are shown.

If the whole images 292 and the extracted images 293 do not fit into a single page of a printing medium, the list box 291 with the same comments shown in it is carried over to a second and following pages, where the rest of the whole images 292 and the extracted images 293 that did not fit into the first page are shown on the left-hand and right-hand sides of the list box 291. Here, the whole images 292 and the extracted images 293 are arranged around the list box 291, so that the comments are arranged near the images. This permits the user to easily grasp the comments relating to particular specified regions 292a.

In this embodiment, specified comments and images in which the specified regions corresponding to those comments are clearly indicated are simultaneously displayed on a display device or printed on a printing medium. This permits the user to easily grasp the comments relating to particular regions. This enhances operability.

Moreover, a plurality of specified regions within a plurality of whole images corresponding to specified comments are shown simultaneously. This makes comparison easy, and thus further enhances operability. Furthermore, printing permits the user to easily grasp the contents of the comments relating to particular specified regions even in an environment where no computer is available. This offers greater convenience.

Here, the designation of specified regions 273 (see FIG. 24) and the entry of comments are handled in the “image overview” procedure (see FIG. 22). However, it is also possible to omit these operations and instead display or print, by the use of an image forming program similar to that of this embodiment, files of image data that have specified regions and comments already written therein.

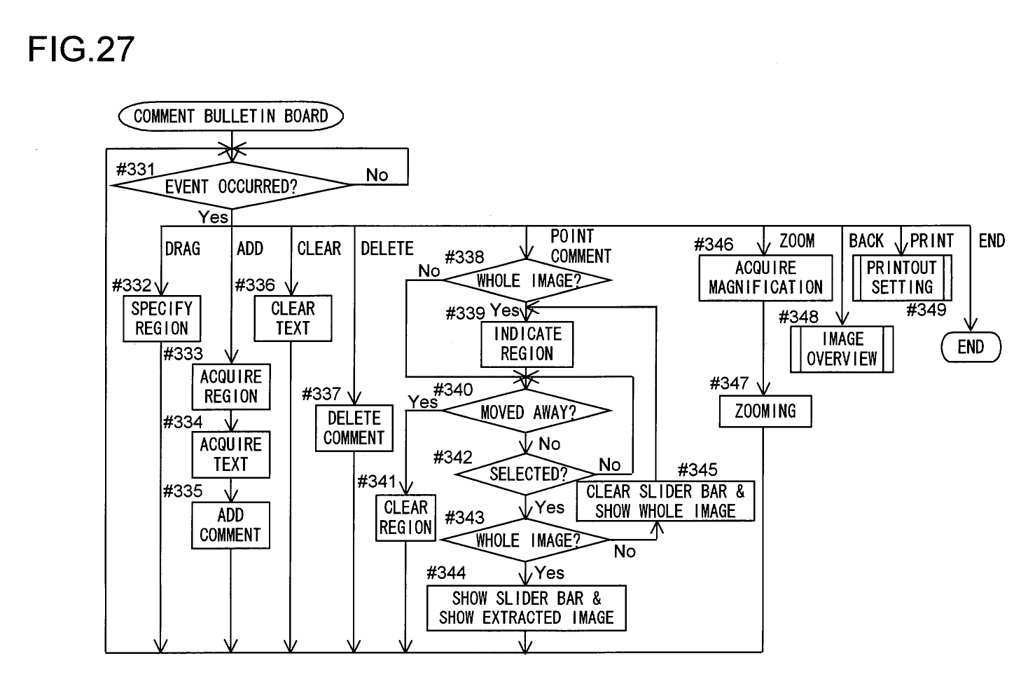

Next, a fifth embodiment of the invention will be described. In this embodiment, compared with the operation in the first embodiment shown in FIGS. 1 to 14 described earlier, the “comment bulletin board” procedure is different from that shown in FIG. 4. In other respects, the operation in this embodiment is the same as that in the first embodiment, and therefore overlapping explanations will not be repeated., FIG. 27 is a flow chart showing the “comment bulletin board” procedure.

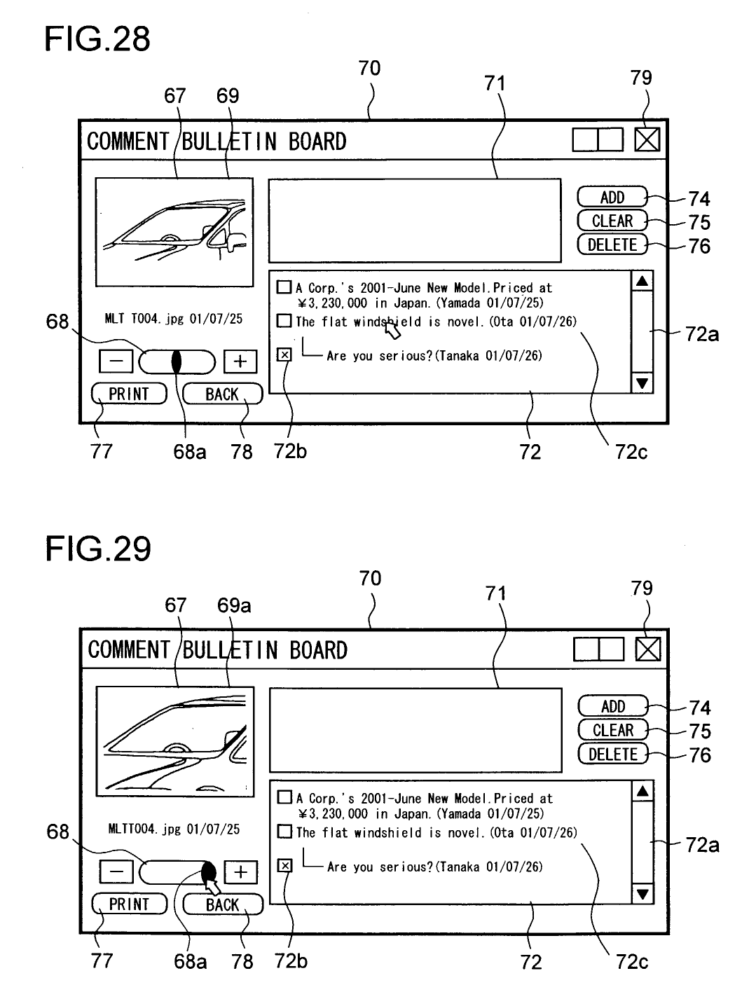

In the “comment bulletin board” procedure, the comment bulletin board screen 70 shown in FIG. 12 described earlier is displayed. In this embodiment, in the image display portion 67 is shown a whole image 73 stored in an image file or an extracted image 69 (see FIG. 28) obtained by extracting and enlarging part of the whole image 73.

In FIG. 27, in step #331, whether an event has occurred or not is monitored so that, whenever an event occurs, the corresponding procedure is executed. When the user specifies part of the whole image 73 with a drag of a pointing device such as a mouse, the program proceeds to step #332, where it indicates the specified part as a specified region 73a within the whole image 73. The program then returns to step #331, going back into the event monitoring state. This permits the user to view images from one desired specified region to another and manage comments for each specified region 73a.

In the event monitoring state (step #331), when the user selects the add button 74, the program proceeds to step #333. In step #333, the range of the specified region 73a indicated in the whole image 73 in the region designation step (step #332) is acquired. As will be described later, if the extracted image 69 (see FIG. 28) is being shown in the image display portion 67, the range of the specified region 73a corresponding to the extracted image 69 is acquired.

In step #334, the comment 71c consisting of text (character data) entered in the text box 71 is acquired. Then, in step #335, the specified region 73a and the comment 71c are incorporated into the image data and stored on the server, and the comment is added on the bulletin board as a comment related to the specified region 73a. Thereafter, the program returns to step #331, going back into the event monitoring state. It is to be noted that, if no specified region 73a is indicated, the comment is added on the bulletin board as a comment relating to the whole image 73.

The comments 72c shown in the list box 72 are each headed with a check box 72b. When the user checks the check box 72b of a comment there and then selects the add button 74, the comment he or she has entered is made open to public on the bulletin board as a reply to the checked comment.

In the event monitoring state (step #331), when the user selects the clear button 75, the program proceeds to step #336, where it clears the data entered in the text box 71. In the event monitoring state, when the user selects the delete button 76, the program proceeds to step #337, where it deletes from the bulletin board the user's own comment of which the check box 72b is checked. Thereafter, the program returns to step #331, going back into the event monitoring state.

In the event monitoring state (step #331), when the user moves the mouse cursor to a comment 72c in the list box 72 and points it, the program proceeds to step #338. In step #338, whether a whole image 73 is being shown in the image display portion 67 or not is checked. If an extracted image 69 (see FIG. 28) is being shown in the image display portion 67, the program proceeds to step #340.

If a whole image 73 is being shown in the image display portion 67, the program proceeds to step #339, where it indicates the specified region 73a corresponding to the pointed comment 72c within the whole image 73. Thus, the user has only to move the mouse cursor to a comment 72c to confirm the corresponding specified region 73a. This enhances operability.

After a comment 72c is pointed, the program waits, in steps #340 and #342, until the mouse cursor is moved away from the comment 72c or the comment 72c is selected with a click of the mouse. When the mouse cursor is moved away from the comment 72c, the program recognizes it in step #340 and proceeds to step #341. In step #341, the program clears the specified region 73a from the screen, and then goes back into the event monitoring state (step #331).

If the comment 72c is selected with a click of the mouse, the program recognizes it in step #342 and proceeds to step #343. A comment 72c may be selected in any other manner. For example, a comment 72c may be selected by pointing it and then pressing a particular function key.

In step #343, whether a whole image 73 is being shown in the image display portion 67 or not is checked again. If a whole image 73 is being shown in the image display portion 67, the program proceeds to step #344, where it shows a slider bar 68 for zoom operation as shown in FIG. 28.

Moreover, the program shows in the image display portion 67 an extracted image 69 obtained by extracting and enlarging the image within the specified region 73a, and then returns to step #331. It is to be noted that, if the user selects the add button 74 with an extracted image 69 shown in the image display portion 67, a comment he or she has entered is treated as a comment related to the extracted image 69 shown.

When an extracted image 69 is already shown in the image display portion 67, the program recognizes it in step #343 and proceeds to step #345, where it clears the slider bar 68. Moreover, the program shows the whole image 73 in the image display portion 67, and then returns to step #339 to indicate the specified region 73a. Now, the screen is as shown in FIG. 12 described earlier.

As shown in FIG. 28, the slider bar 68 has a button 68a. This button 68a can be slid on the screen as it is moved, for example, with a drag of a mouse or through operation of a keyboard. By manipulating the button 68a, the user can zoom in and out on the extracted image 69.

In the event monitoring state (step #331), when the user moves the button 68a, a zoom event occurs, which causes the program to proceed to step #346. Moving the button 68a leftward results in reducing the extracted image 69, and moving it rightward results in enlarging the extracted image 69. The zoom magnification varies according to the displacement of the button 68a.

In step #346, the zoom magnification is acquired on the basis of the direction and displacement in and over which the button 68a is moved. In step #347, zooming is performed so that the extracted image 69 is shown at the acquired zoom magnification in the image display portion 67. Thereafter, the program returns to step #331. This permits the user to view the extracted image 69 at a desired magnification. This enhances operability.

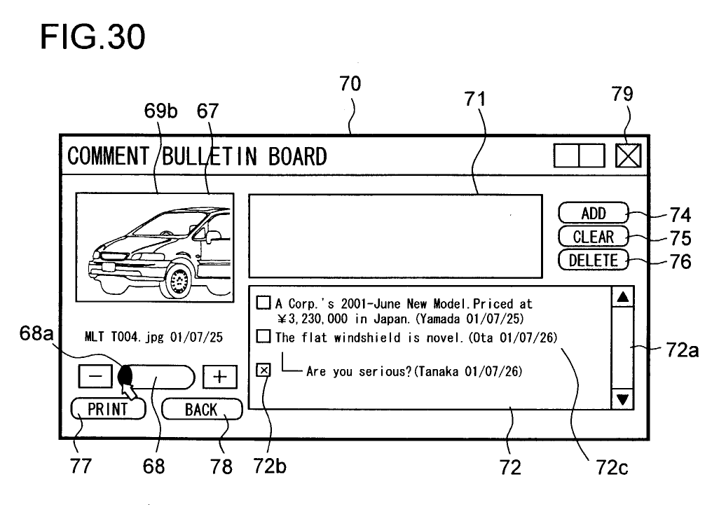

For example, FIG. 29 shows a case in which the button 68a is moved rightward so that an enlarged version 69a of the extracted image 69 of FIG. 28 is shown in the image display portion 67. On the other hand, FIG. 30 shows a case in which the button 68a is moved leftward so that a reduced version 69b of the extracted image 69 of FIG. 28 is shown in the image display portion 67. Here, it is desirable to show the extracted image 69 so that its center coincides before and after zooming. This permits the user to easily grasp to which part the extracted image corresponds.

In the event monitoring state (step #331), when the user selects the back button 78, the program proceeds to step #348, where it calls the “image overview” procedure shown in FIG. 3 described earlier. If the user selects the end button 79, the image forming program terminates. If the user selects the print button 77, the program proceeds to step #349, where it calls the “printout setting” procedure shown in FIG. 5 described earlier.

In this embodiment, extracted images 92a, obtained by extracting the images within specified regions 91a from the whole image 91, and the comments 92b relating to those specified regions can be simultaneously displayed or printed. This permits the user to easily grasp which comments relate to which regions. This enhances operability. Moreover, printing permits the user to easily grasp the contents of the comments relating to a number of specified regions even in an environment where no computer is available. This offers greater convenience.

Moreover, when a comment 72c is selected in the comment bulletin board screen 70, the extracted image 73a corresponding to that comment 72c is shown. This permits the user to more easily grasp which comments relate to which regions.

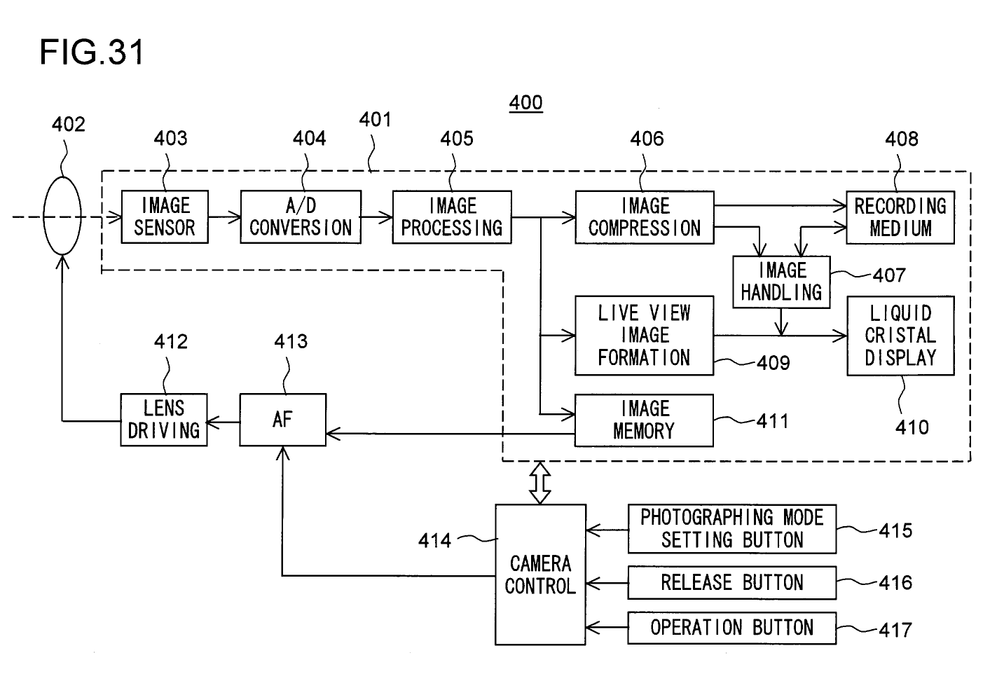

Next, a sixth embodiment of the invention will be described with reference to FIG. 31. FIG. 31 is a block diagram showing a digital camera incorporating the image forming program of the fifth embodiment. The image forming program is stored in an image handling portion 407.

The digital camera 400 has a camera control portion 414 including a CPU for controlling the different portions of the camera. The camera control portion 414 receives signals produced by a photographing mode setting button 415, a release button 416, and an operation button 417.

When the photographing mode setting button 415 is operated, the camera control portion 414 selects one of different photographing modes, such as a mode for photographing a night scene. When the release button 416 is operated, the camera control portion 414 performs exposure operation. When the operation button 417 is operated, the camera control portion 414 permits the different portions of the digital camera 400 to be operated.

Moreover, the camera control portion 414 also controls an AF (automatic focusing) portion 413 and an image forming portion 401. In the stage preceding the image forming portion 401, there is provided an optical lens 402. Within the image forming portion 401, in the stage following the optical lens 402, there is provided an image sensor 403 such as a CCD. In the stage following the image sensor 403, there are provided, through an A/D (analog-to-digital) conversion portion 404, an image processing portion 405 that performs noise elimination and other processing.

In the stage following the image processing portion 405, there is provided an image compression portion 406, which is connected to a recording medium 408. To the image processing portion 405 is also connected, in parallel with the image compression portion 406, a live view image formation portion 409. The live view image formation portion 409 is connected to a liquid crystal display portion 410, and serves to convert the output signal of the image processing portion 405 into a display signal for the liquid crystal display portion 410.

In the stage following the image compression portion 406 is provided the image handling portion 407, in which an image forming program similar to that of the fourth embodiment is executed. The output side of the image handling portion 407 is connected to the recording medium 408 and to the liquid crystal display portion 410.

In the image processing portion 405, there is provided, parallel with the live view image formation portion 409, an image memory 411 such as a RAM for temporary storage of the output signal of the image processing portion 405. The image memory 411 is connected to the AF portion 413, and the AF portion 413 is connected to a lens driving portion 412 for driving the optical lens 402.

In the digital camera 400 configured as described above, the light that has passed through the optical lens 402 is subjected to photoelectric conversion performed by the image sensor 403, which thereby outputs a video signal. The video signal is converted into a digital signal by the A/D conversion portion 404, and is then converted into a predetermined signal by the image processing portion 405.

The output signal of the image processing portion 405 is fed to the image compression portion 406, to the live view image formation portion 409, and to the image memory 411. In the image compression portion 406, the signal fed thereto is subjected to data compression so as to be recorded as image data on the recording medium 408. In the live view image formation portion 409, the signal fed thereto is converted into a predetermined signal, and is then fed to the liquid crystal display portion 410 so that the image captured through the optical lens 402 is displayed on the liquid crystal display portion 410.

In the image memory 411, every time an image is photographed, the data of the image that has passed through the optical lens 402 is stored. The AF portion 413 takes out the data stored in the image memory 411 with predetermined timing, and controls the lens driving portion 412 on the basis of that data. The lens driving portion 412 drives the optical lens 402 to achieve automatic focusing.

Through the image forming program executed in the image handling portion 407, an image based on the image data output from the image compression portion 406 or based on the image data stored on the recording medium 408 is displayed on the liquid crystal display portion 410. The user, by operating the image forming program, can handle the image displayed on the liquid crystal display portion 410 in the same manner as in the fifth embodiment. In this way, it is possible to achieve the same effects as in the fifth embodiment.

Moreover, the user can enter specified regions 73a and comments 72c (see FIG. 12 for both) and store them on the recording medium 408. In this embodiment, an image forming program is incorporated in a digital camera 400. It is possible, however, to incorporate the image forming program in any other type of personal digital assistant.

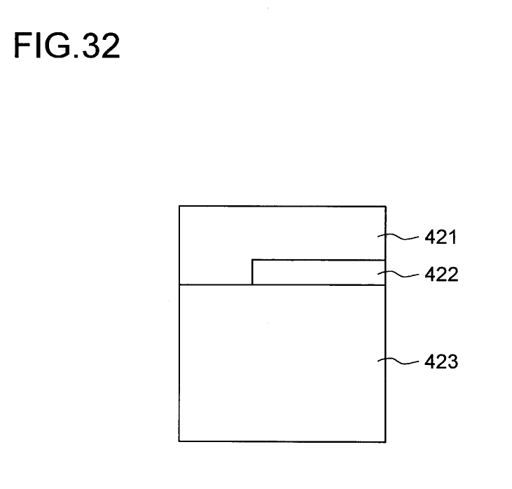

In the first to sixth embodiments, image data is stored as shown in FIG. 32. As shown in this figure, to the data 423 of a whole image itself, there is added a header region 421 in which to store the information pointing to the whole image. Moreover, in part of the header region 421, region data indicating the positions and sizes of specified regions 73a or 273 is stored. This makes it possible to read the region data 412 from a predetermined position to obtain an extracted image.

In the first to sixth embodiments, an image forming program is stored and executed on an Internet server. It is also possible, however, to install the image forming program in a local drive and execute it on a stand-alone basis.

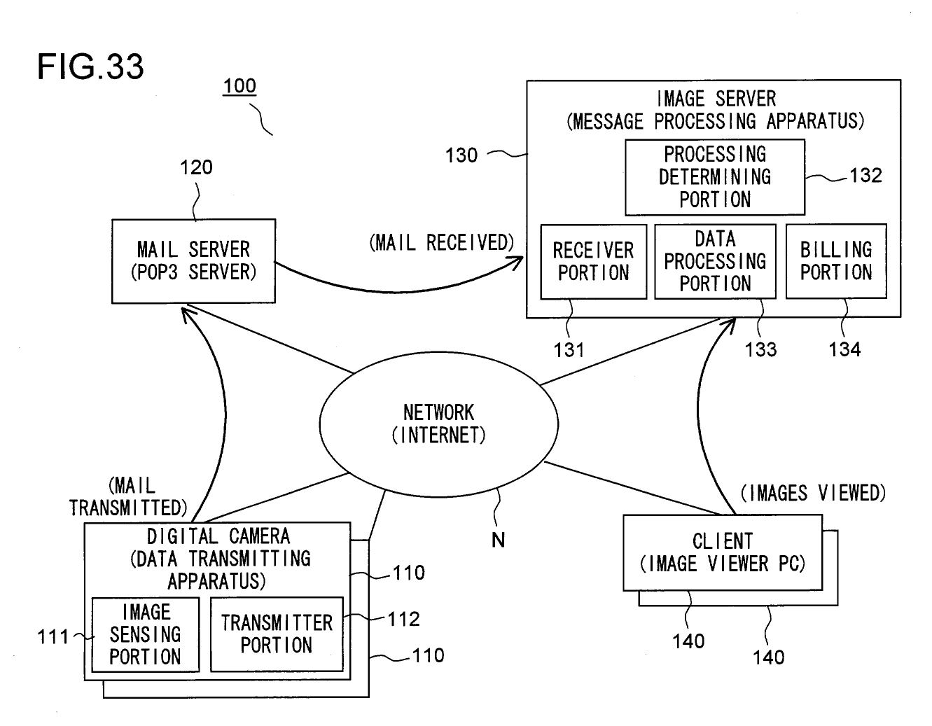

Next, a seventh embodiment of the invention will be described. FIG. 33 is a diagram schematically showing the configuration of the message processing system of this embodiment. This embodiment deals with an example in which electronic mail is used for electronic messaging and image data (still image data) is transmitted as multimedia data by the use of such electronic messaging.

As shown in FIG. 33, the message processing system 100 includes a plurality of digital cameras 110, a mail server computer (hereinafter referred to simply as the “mail server” also) 120, a server computer (hereinafter referred to simply as the “image server” also) 130, and a plurality of client computers (hereinafter referred to simply as the “clients” also) 140.

The individual digital cameras 110, the mail server 120, the image server 130, and the individual clients 140 are interconnected over a network N so that they can perform data communication with one another. Among these terminal devices, the image server 130 functions as a message processing apparatus.

Here, a network denotes a communications network over which data communication is carried out, that is, a communications network of any type composed of electric communications lines (including optical communications lines), such as the Internet, a LAN, WAN, CATV, or ICN (inter-community network).

Each terminal device may be connected to the network on an all-the-time basis by the use of a dedicated line or the like, or on a temporary basis, for example through dial-up connection, by the use of a telephone line of an analog or digital (ISDN) type. The transfer of data may be achieved on a wireless or wired basis.

In this message processing system 100, image data (hereinafter referred to simply as “images” also) photographed by a digital camera 110 can be attached to electronic mail (hereinafter referred to simply as “e-mail” or “mail” also) so as to be sent (transmitted) to the image server 130. Here, the operator of the digital camera 110 selects, from among a plurality of mail addresses, a mail address that is appropriate for the type or character of the images photographed, and specifies the selected mail address as the recipient (or the destination) of the mail.

The digital camera 110 then sends, by using the communication function of the digital camera 110 or by another means, the mail having the image data attached thereto (image-accompanied mail) to the specified recipient. Here, it is assumed that “still image data” is sent as the image data. It is possible, however, to send “moving image data” as the image data as will be described later.

The image server 130 manages a plurality of recipient mail addresses, and receives through the mail server 120 image-accompanied mail addressed to those mail addresses. The image server 130 can receive not only image-accompanied mail sent from a single digital camera 110 but also image-accompanied mail sent from any of the plurality of digital cameras 110.

Having received image-accompanied mail, the image server 130 extracts images (more precisely, image data) from the mail, and performs predetermined data processing on the images. What data processing to perform here has previously been determined for each mail recipient (i.e., for each destination address). Thus, the image server 130 performs on the images attached to mail predetermined data processing according to the address (recipient) to which the mail is addressed. Examples of the data processing include conversion of the images into a predetermined display format and predetermined image correction on the images.

Moreover, the image server 130 is established as a WWW (World Wide Web) server so that each client 140 can access it. This permits each client 140 to view the images converted into a predetermined display format by the image server 130. Specifically, the client 140, by using any HTML browser, can view a Web page written in HTML (Hypertext Markup Language).

In this system, the user of a digital camera 110 can perform predetermined data processing on the images he or she has photographed simply by selecting, from among a plurality of mail addresses, a mail address appropriate for the photographed images and then sending mail having the photographed images attached thereto to the selected mail address.

Here, as will be described later, what processing to perform on the images is determined in the image server 130, and therefore the user need not make such a setting on the digital camera, of which the operability is inferior to that of, for example, a personal computer. In this way, this message processing system helps reduce the need for the user to enter characters in the digital camera 110 and thereby reduce the burden of operation on the sender of image-accompanied mail.

The digital camera 110 has an image sensing portion 111 and a transmitter (sender) portion 112. The image sensing portion 111, by the use of a taking lens, images an image of a subject on an image sensor (such as CCD), which then performs photoelectric conversion to produce image data as electronic information.

The transmitter portion 112 is a functional portion that serves to establish connection with the network N, and is provided inside the body of the digital camera 110 itself or in a card removably inserted into the body thereof The transmitter portion 112 permits the images photographed by the use of the image sensing portion 111 (i.e., the photographed images) to be transmitted (sent) to a specified address. The operations of specifying an address, transmitting (sending) images, etc. will be described later.

The mail server 120 is a server that uses a protocol such as POP3 (Post Office Protocol Version 3). Mail sent to a mail address managed by the mail server 120 is first stored in this mail server 120. The recipient him or herself to which the mail is addressed can receive it by accessing the mail server 120.

Here, the image server 130 accesses the mail server 120 on a regular (or irregular) basis, and receives mail addressed to recipient addresses managed by the image server 130 . In this way, image-accompanied mail sent from a digital camera 110 is transmitted through the mail server 120 and received by the image server 130.

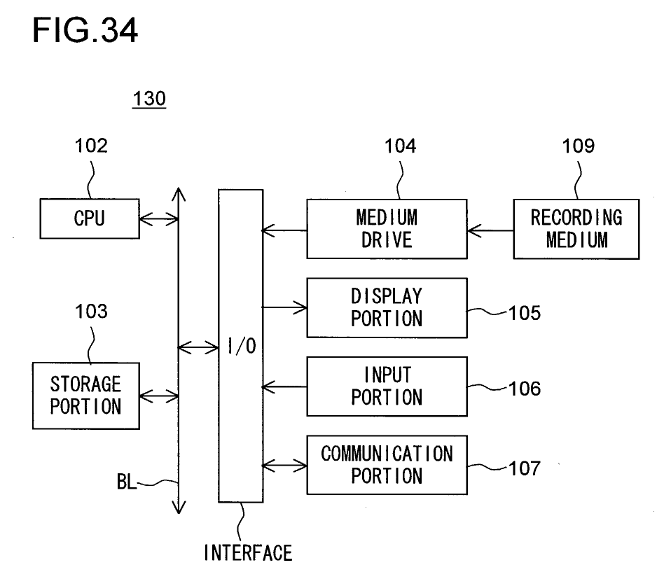

FIG. 34 is a diagram schematically showing the hardware configuration of the image server 130. The image server 130 is configured as a computer system (hereinafter referred to simply as the “computer” also) composed of a CPU 102, a storage portion 103 including, for example, a semiconductor memory and a hard disk, a medium drive 104 for reading information from various recording media, a display portion 105 including, for example, a monitor, an input portion 106 including, for example, a keyboard and a mouse, and a communication portion 107 for conducting communication with an external device.

The CPU 102 is connected, through a bus line BL and an input/output interface IF, to the storage portion 103, medium drive 104, display portion 105, input portion 106, communication portion 107, etc. The medium drive 104 reads information recorded on a portable recording medium 109 such as a CD-ROM, DVD (digital versatile disk), flexible disk, or the like.

In this image server 130, software programs (hereinafter referred to simply as the “programs” also) stored on the recording medium 109 are read therefrom and executed by the CPU 102 and other blocks. This makes the image server 130 perform the various operations described below.

The programs having the various functions may be supplied (or distributed) to the computer not only by means of the recording medium 109 but also through the communication portion 107 over a network (communication line) such as a LAN or the Internet.

In more detail, the image server 130, as shown in FIG. 33, has various functional portions such as a receiver portion 131, a processing determining portion 132, a data processing portion 133, a billing portion 134. The receiver portion 131 has the function of receiving electronic mail including images. The processing determining portion 132 has the function of determining the data processing to be performed on the images included in electronic mail according to the recipient of the electronic mail.

The data processing portion 133 has the function of performing on the images included in the electronic mail received by the receiver portion 131 the predetermined data processing previously determined by the processing determining portion 132 according to the recipient thereof The billing portion 134 has the function of billing users for charges. The details of the data processing will be described later.

The mail server 120 and the clients 140 are each configured as a computer configured in a similar manner to the one described above. That is, in each of these computers, predetermined programs are read and executed to perform various operations. This makes the mail server 120 and the clients 140 perform their respective operations.

As described earlier, a client 140 can view images displayed in a predetermined format by the image server 130. Specifically, the client 140, by using an HTML browser, has only to view home pages at specified URLs classified by the theme. The operations of such viewing etc. will be described in detail later.

Next, the operation of the message processing system 100 will be described. First, various setting and other operations in the image server 130 will be described. As will be described later, various kinds of data processing are performed on image data according to the settings made here in the administration operation.

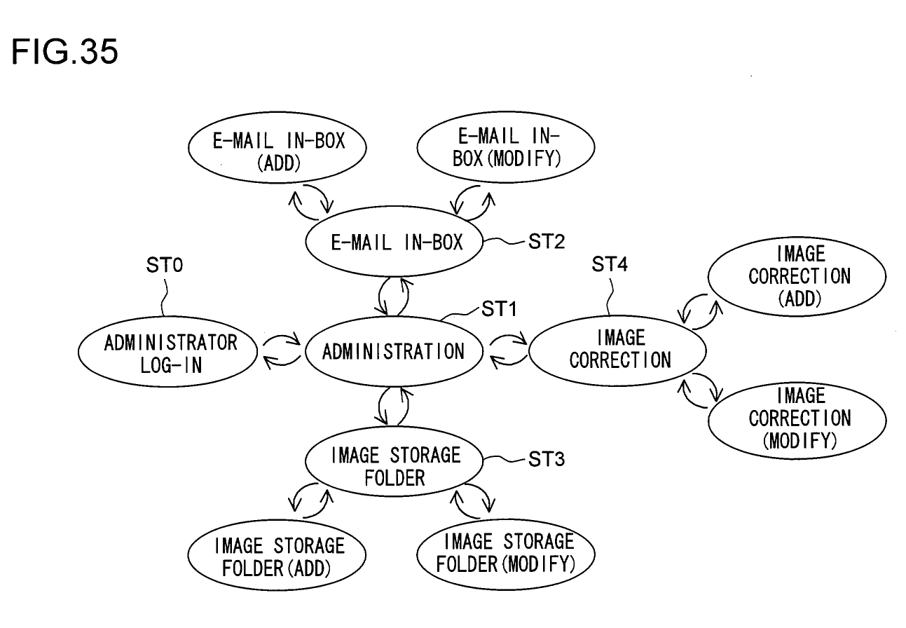

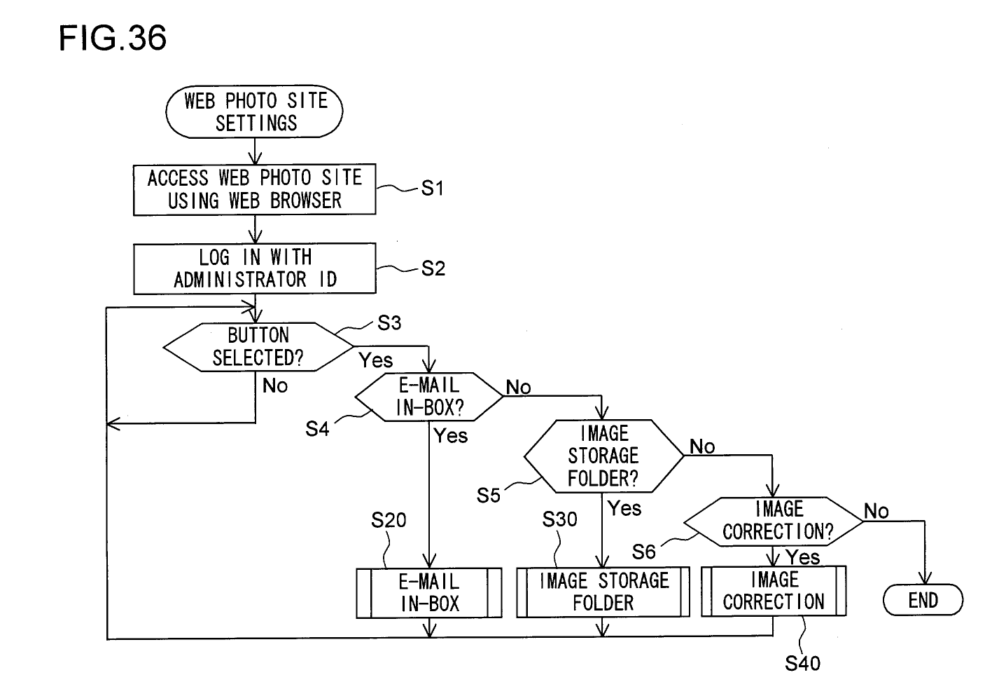

FIG. 35 is a diagram showing the state transition of the image server 130 in the administration operation. FIG. 36 is a flow chart of the procedure of the administration operation. The following descriptions deal with a case where setting operations targeted at the image server 130 is performed on a computer other than the image server 130. Needless to say, the setting operations described below may be performed on the image server 130 itself

First, in step S1, the administrator accesses the image server 130 (referred to as the “Web photo site” also) as a Web server (WWW server) by using a Web browser (HTML browser) running on a predetermined computer for the administrator (the administrator's computer, not shown).

In step S2, the administrator, through the administrator's computer, sends the administrator's ID (identification code) to the image server 130. That is, the administrator tries to log in by using the administrator's ID. This state corresponds to the state ST0 shown in FIG. 35.

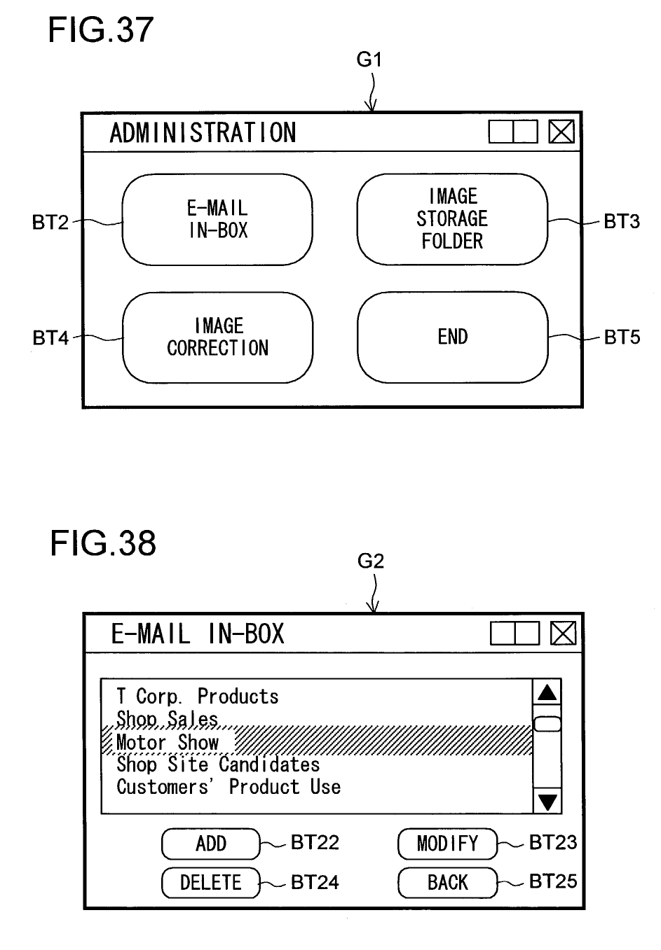

The image server 130, if it recognizes the administrator's ID as authentic, permits log-in, and sends to the administrator's computer the data for displaying an initial screen G1 (see FIG. 37). In response, the initial screen G1 is displayed on the administrator's computer. This state corresponds to the state ST1 shown in FIG. 35.

FIG. 37 is a diagram showing the initial screen G1 of the administration operation. In the initial screen G1, there are shown four menu buttons BT2, BT3, BT4, and BT5. When one of the four buttons BT2, BT3, BT4, and BT5 is selected, the corresponding sub-menu is shown.

Specifically, in step S3 in FIG. 36, when any of the buttons is recognized as selected, the procedure proceeds to step S4. In step S4, if the “e-mail in-box” button BT2 is recognized as selected, the procedure proceeds to step S20. On the other hand, in step S4, if the button BT2 is recognized as not selected, the procedure proceeds to step S5.

In step S5, if the “image storage folder” button BT3 is recognized as selected, the procedure proceeds to step S30. On the other hand, in step S5, if the button BT3 is recognized as not selected, the procedure proceeds to step S6.

In step S6, if the “image correction” button BT4 is recognized as selected, the procedure proceeds to step S40. On the other hand, in step S6, if the button BT4 is recognized as not selected, the “end” button BT5 is regarded as selected, and operations for terminating the administration operation (specifically, log-out and other operations) are performed.

First, the procedure that follows when the button BT2 is selected (step S20) in the initial screen G1 will be described. When the button BT2 is selected, the image server 130 goes into the state ST2 shown in FIG. 35, and the screen G2 shown in FIG. 38 is displayed on the administrator's computer. In this embodiment, it is assumed that, when images are stored, they are classified into a number of groups with different themes, and that the administrator is responsible for the selection of such themes and other operations related there.

FIG. 38 shows how a plurality of “themes,” such as “T Corp. Products,” “Shop Sales,” “Motor Show,” “Shop Site Candidates,” “Clients' Product Use,” are shown in the screen G2. Images sent from the individual digital cameras 110 to the image server 130 are classified into groups with those different themes according to the recipient addresses (recipients) of mail to which the images are attached. In this screen G2, setting operations for associating the themes and the mail addresses (recipients) are performed.

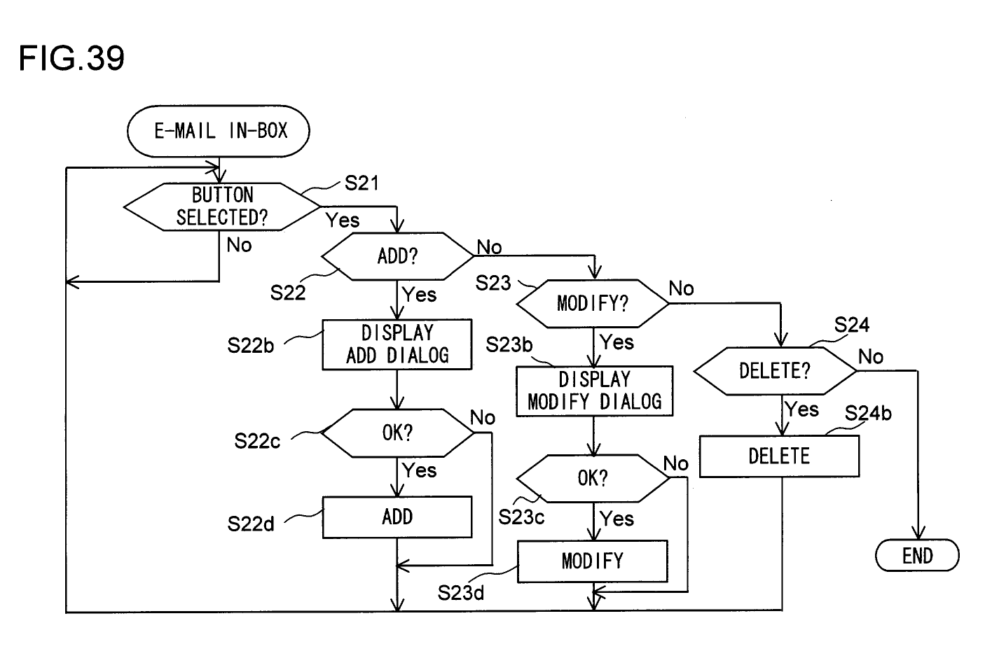

In the screen G2 shown in FIG. 38, there are shown four menu buttons BT22, BT23, BT24, and BT25. When one of these four buttons is selected, the corresponding operation is performed. Now, this operation will be described with reference to the flow chart shown in FIG. 39.

First, in step S21, when any of the buttons is recognized as selected, the procedure proceeds to step S22. In step S22, if the “add” button BT22 is recognized as selected, the procedure proceeds to step S22b. On the other hand, in step S22, if the button BT22 is recognized as not selected, the procedure proceeds to step S23.

In step S23, if the “modify” button BT23 is recognized as selected, the procedure proceeds to step S23b. On the other hand, in step S23, if the button BT23 is recognized as not selected, the procedure proceeds to step S24.

In step S24, if the “delete” button BT24 is recognized as selected, the procedure proceeds to step S24b. On the other hand, in step S24, if the button BT24 is recognized as not selected, the “end” button BT25 is regarded as selected, and the state ST1 is restored with the screen G1 (see FIG. 37) displayed.

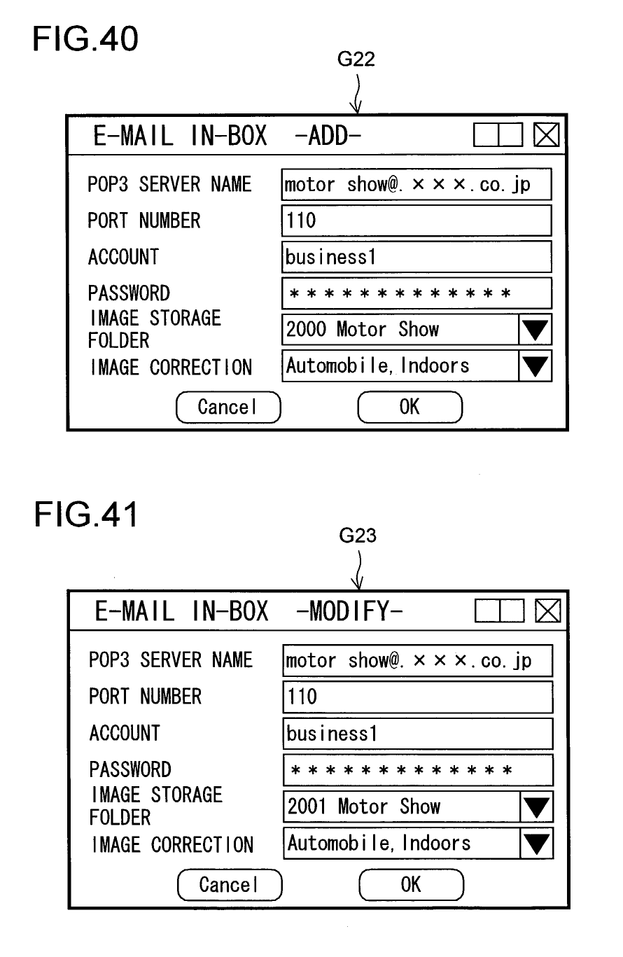

For example, a new “theme” can be created and registered by first selecting the “add” button BT22. When the name of the theme (here “Motor Show”) is entered in the dialog box shown in response to the selection of the button BT22, then, in step S22b, the screen G22 of the “add” dialog box shown in FIG. 40 is displayed.

In the screen G22, various items are set. As examples of the items set here, there are shown “POP3 server name,” which specifies the name of the mail server 120, “port number,” which specifies the port used in communication, “account,” which determines part of each mail address, “password,” which specifies the password used to prevent unauthorized access, “image storage folder,” which specifies the folder in which images are stored, and “image correction,” which specifies the contents of correction to be performed on the images.

The operator enters appropriate data in the boxes corresponding to the individual items. Here, in the box of “POP3 server name” is entered “motorshow@xxx.co.jp”; in the box of “port number” is entered “110”; in the box of “account” is entered “business1”; in the box of “password” is entered an appropriate combination of characters, symbols, and numerals.

By using these settings, the image server 130 can access the mail server 120. Here, it is advisable that the reading of mail be performed on a regular basis at fixed intervals.

When the above settings are registered, the theme “Motor Show” is associated with the mail address “business1@xxx.co.jp.” In other words, the image server 130 recognizes the images attached to mail sent to that mail address as relating to the theme “Motor Show.”

Moreover, in the box of “image storage folder” is entered “2000 Motor Show,” and in the box of “image correction” is entered “automobiles, indoors.” Thus, the theme is associated also with a predetermined image storage folder and with a predetermined image correction processing type. The details of the “image storage folder” and the “image correction” will be described later.

After the entry of these items, when the “OK” button is selected, the entered data is registered, and the added theme is established in the image server 130 (steps S22c and S22d). Now, the settings for the new theme are complete. If the “cancel” button is selected instead, the operation for adding a new theme is aborted.

In this case, the procedure returns to step S21 to wait for one of the buttons in the screen G2 to be selected. The sequence of operations described above may be repeated to make settings for other themes than “Motor Show.”

An already-existing “theme” can be modified by first selecting the “theme” to be modified with a mouse and then selecting the “modify” button BT23. The procedure then proceeds to step S23b, and the screen G23 of the “modify” dialog box shown in FIG. 41 is displayed.

In the screen G23, the various items already set can be modified. Specifically, the operator has only to enter modified data in the boxes of the relevant items. In FIG. 41, the image storage folder is modified to “2001 Motor Show.”

After the modification of the items, when the “OK” button is selected, the modified data for the theme to be modified is registered to replace the older data. In other words, in the image server 130, the modified data is reflected in the data for the theme to be modified (steps S23c and S23d). Now, the modification of the theme is complete.

If the “cancel” button is selected instead, the operation for modifying the theme is aborted. In this case, in the image server 130, the data before the modification is maintained, and the procedure returns to step S21 to wait for one of the buttons in the screen G2 to be selected.

An already-existing “theme” can be deleted by first selecting the “theme” to be deleted with a mouse and then selecting the “delete” button BT24. The procedure then proceeds to step S24b. In step S24b, a confirmation dialog box (not shown) appears, and, when the “OK” button in the confirmation dialog box is selected, the theme selected for deletion is actually deleted. Now, the deletion of the theme is complete.

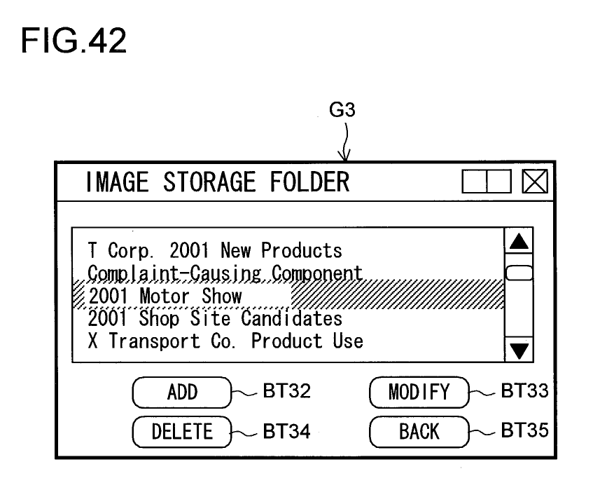

Next, the procedure that follows when the button BT3 is selected (step S30) in the initial screen G1 (see FIG. 37) described earlier will be described. When the button BT3 is selected, the image server 130 goes into the state ST3 shown in FIG. 35, and the screen G3 shown in FIG. 42 is displayed on the administrator's computer. In this screen G3, setting operations for establishing correspondence between image storage folders associated with specific themes and display templates are performed.

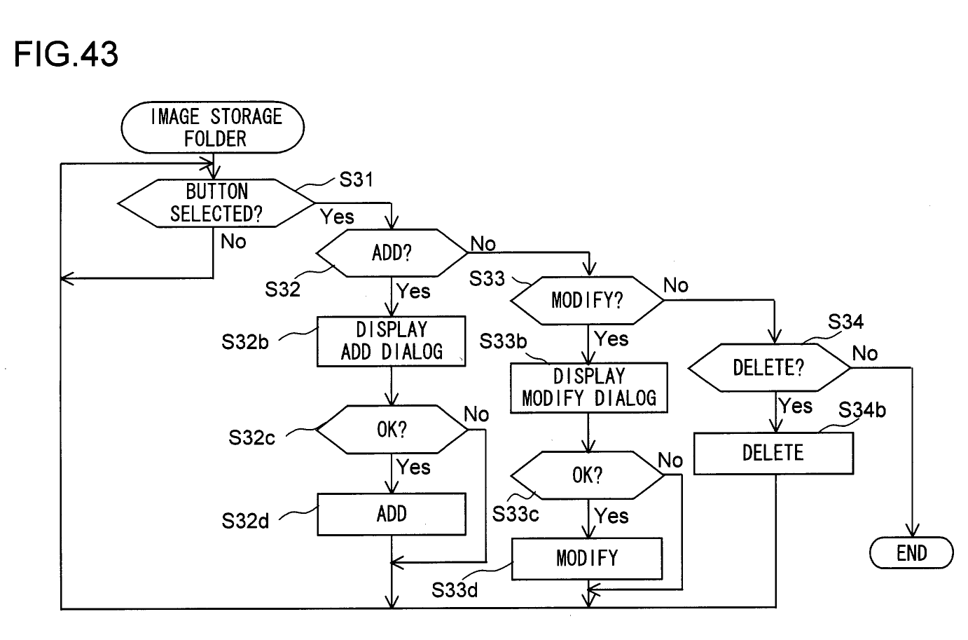

In the screen G3, there are shown four menu buttons BT32, BT33, BT34, and BT35. When one of these four buttons is selected, the corresponding operation, including the display of the corresponding setting screen, is performed. Now, this operation will be described with reference to the flow chart shown in FIG. 43.

First, in step S31, when any of the buttons is recognized as selected, the procedure proceeds to step S32. In step S32, if the “add” button BT32 is recognized as selected, the procedure proceeds to step S32b. On the other hand, in step S32, if the button BT32 is recognized as not selected, the procedure proceeds to step S33.

In step S33, if the “modify” button BT33 is recognized as selected, the procedure proceeds to step S33b. On the other hand, in step S33, if the button BT33 is recognized as not selected, the procedure proceeds to step S34.

In step S34, if the “delete” button BT34 is recognized as selected, the procedure proceeds to step S34b. On the other hand, in step S34, if the button BT34 is recognized as not selected, the “back” button BT35 is regarded as selected, and the state ST1 (see FIG. 35) is restored with the screen G1 (see FIG. 37) displayed.

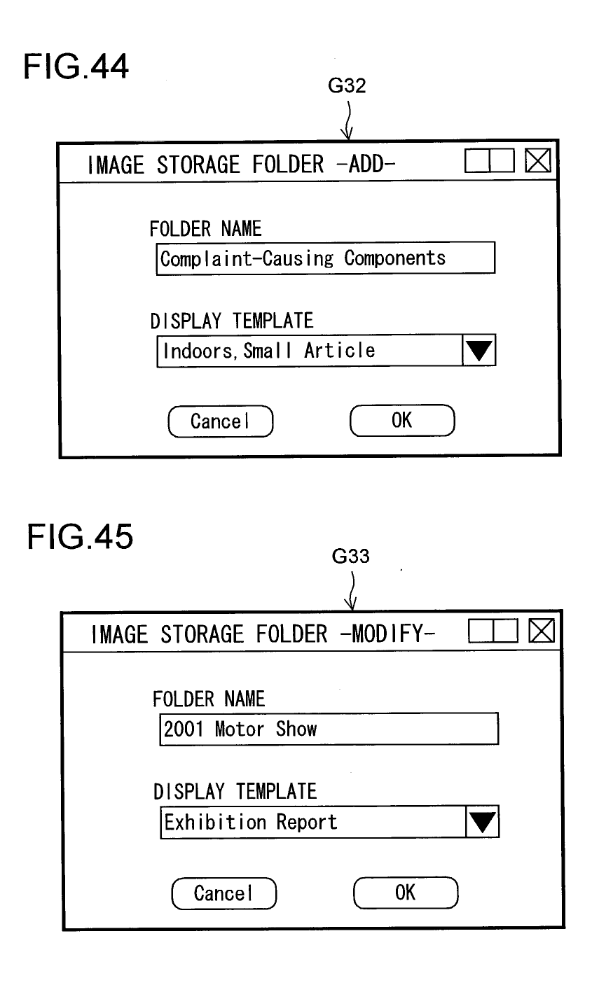

For example, a new “image storage folder” can be created and registered by first selecting the “add” button BT32. The procedure then proceeds to step S32b. In step S32b, in response to the selection of the button BT32, the screen G32 shown in FIG. 44 is displayed. In this screen G32, various items are set.

As examples of the items set here, there are shown “folder name” and “display template.” The operator enters appropriate data in the boxes corresponding to the individual items. Here, in the box of “folder name” is entered a new name “Complaint-Causing Components,” and in the box of “display template” is entered “Indoors, Small Article” selected from the list of alternatives.

After the entry of these items, when the “OK” button in the screen G32 is selected, the entered data is registered, and a new image storage folder is created in the image server 130 (steps S32c and S32d). Now, the settings for the new image storage folder are complete.

If the “cancel” button is selected instead, the operation for adding a new folder is aborted. In this case, the procedure returns to step S31 to wait for one of the buttons in the screen G3 to be selected. The sequence of operations described above may be repeated to create other image storage folders.

An already-existing “image storage folder” can be modified by first selecting the “image storage folder” to be modified with a mouse and then selecting the “modify” button BT33. This causes the screen G33 of the “modify” dialog box shown in FIG. 45 to be displayed. In the screen G33, the various items already set can be modified. Specifically, the operator has only to enter modified data in the boxes of the relevant items.

After the modification of the items, when the “OK” button is selected, the modified data for the image storage folder to be modified is registered to replace the older data. In other words, in the image server 130, the modified data is reflected in the data for the image storage folder to be modified (steps S33c and S33d). Now, the modification of the image storage folder is complete.

If the “cancel” button is selected instead, the operation for modifying the image storage folder is aborted. In this case, in the image server 130, the data before the modification is maintained, and the procedure returns to step S31 to wait for one of the buttons in the screen G3 to be selected.

For example, when the modified data shown in FIG. 45 is registered, the image storage folder “2001 Motor Show,” which is already associated with the theme “Motor Show” is further associated with the display template named “Exhibition Report.” On the other hand, the theme “Motor Show” is associated with the main address “business1@xxx.co.jp.”

Thus, the image server 130 recognizes the images attached to mail sent to the above mail address as images to be stored in the image storage folder “2001 Motor Show,” and in addition recognizes those images as images to be displayed by using the display template named “Exhibition Report.”

An already-existing “image storage folder” can be deleted by first selecting the “image storage folder” to be deleted with a mouse and then selecting the “delete” button BT34. When, in the confirmation dialog box (not shown) appearing in response, the “OK” button is further selected, the image storage folder selected to be deleted is actually deleted (step S34b). Now, the deletion of the image storage folder is complete.

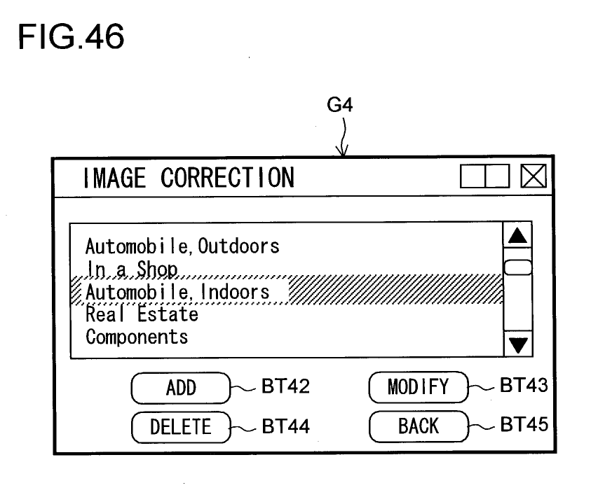

Next, the procedure that follows when the button BT4 is selected (step S40) in the initial screen G1 (see FIG. 37) described earlier will be described. When the button BT4 is selected, the image server 130 goes into the state ST4 shown in FIG. 35, and the screen G4 shown in FIG. 46 is displayed on the administrator's computer. In this screen G4, the contents of the image correction processing type associated with each theme can be set. Here, an “image correction processing type” refers collectively to a set of various kinds of image processing to be performed on images classified under a particular theme.

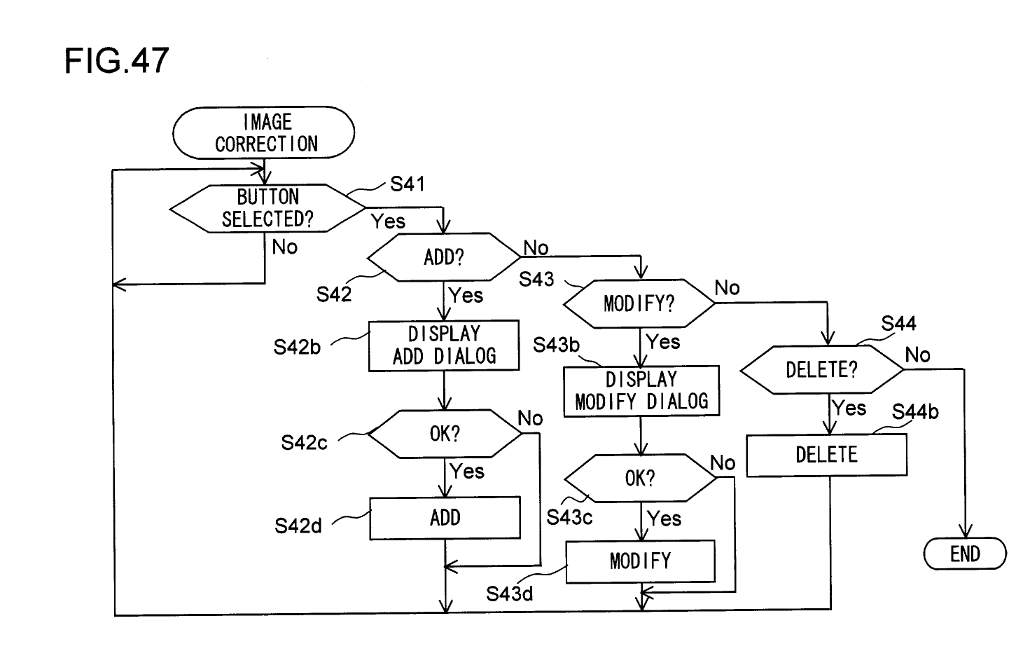

In the screen G4, there are shown four menu buttons BT42, BT43, BT44, and BT45. When one of these four buttons is selected, the corresponding operation, including the display of the corresponding setting screen, is performed. Now, this operation will be described with reference to the flow chart shown in FIG. 47.

First, in step S41, when any of the buttons is recognized as selected, the procedure proceeds to step S42. In step S42, if the “add” button BT42 is recognized as selected, the procedure proceeds to step S42b. On the other hand, in step S42, if the button BT42 is recognized as not selected, the procedure proceeds to step S43.

In step S43, if the “modify” button BT43 is recognized as selected, the procedure proceeds to step S43b. On the other hand, in step S43, if the button BT43 is recognized as not selected, the procedure proceeds to step S44.

In step S44, if the “delete” button BT44 is recognized as selected, the procedure proceeds to step S44b. On the other hand, in step S44, if the button BT44 is recognized as not selected, the “back” button BT45 is regarded as selected, and the state ST1 (see FIG. 35) is restored with the screen G1 (see FIG. 37) displayed.

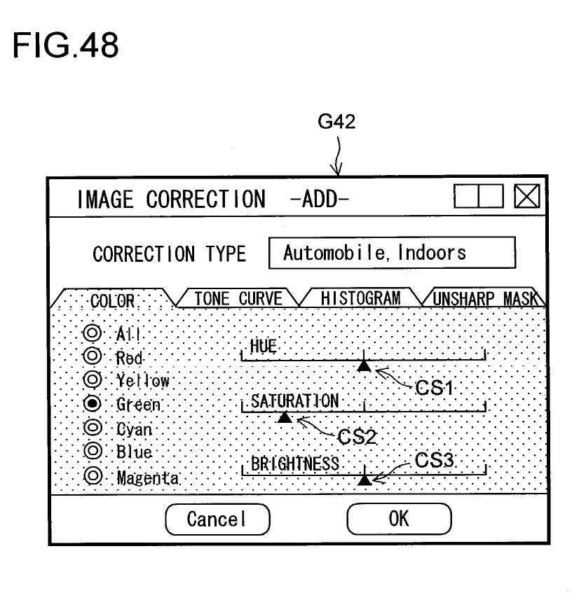

For example, a new “image correction processing type” can be created and registered by first selecting the “add” button BT42. The procedure then proceeds to step S42b. In step S42b, in response to the selection of the button BT42, the screen G42 of the “add” dialog box shown in FIG. 48 is displayed. In this screen G42, various items are set.

In FIG. 48, as examples of the items set here, there are shown “hue correction,” “saturation correction,” “brightness correction,” “tone curve correction,” “histogram correction,” and “unsharp mask correction.” The operator makes appropriate settings for the individual items.

The example being described deals with a case where, for the type of image correction processing named “Automobile, Indoors,” settings of hue, saturation, and brightness are made with respect to each of the basic colors. Specifically, in a left-hand portion of the screen, there are vertically arranged a plurality of (seven) radio buttons. For example, with one of the radio buttons, for example “green,” selected, by moving the cursors CS1, CS2, and CS3 on the screen, it is possible to increase or decrease the hue, saturation, and brightness of “green.” Similar settings are possible with the other basic colors.

Furthermore, appropriate settings are possible also with respect to “tone curve correction” for correcting the tone curve defining the relationship between the input gradations and the output gradations. Moreover, appropriate settings are possible also with respect to “histogram correction” for correcting the overall brightness and contrast by controlling the distribution of gradations on the basis of the histogram of individual gradations, and also with respect to “unsharp mask” for improving sharpness.

After the settings for each kind of correction are made, when the “OK” button in the screen G42 is selected, the new image correction processing type is registered in the image server 130 (steps S42c and S42d). Now, the settings for the new image correction processing type are complete.

If the “cancel” button is selected instead, the operation for adding a new image correction processing type is aborted. In this case, the procedure returns to step S41 to wait for one of the buttons in the screen G4 to be selected. The sequence of operations described above may be repeated to create other image correction processing type.

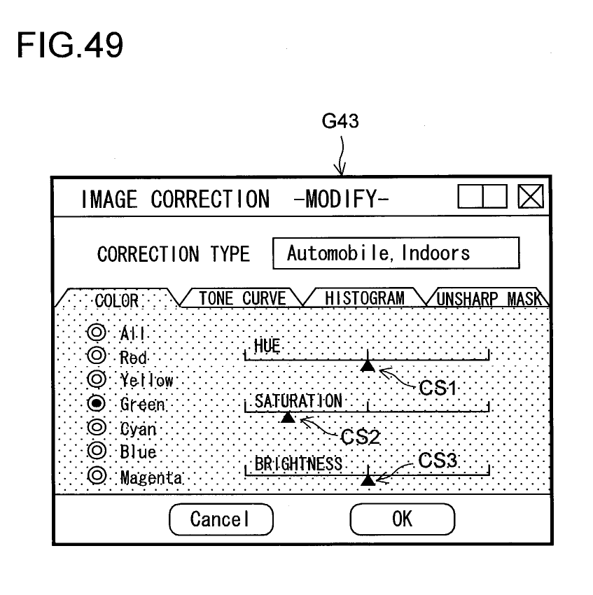

An already-existing “image correction processing type” can be modified by first selecting the “image correction processing type” to be modified with a mouse and then selecting the “modify” button BT43. The procedure then proceeds to step S43b. In step S43b, the screen G43 of the “modify” dialog box shown in FIG. 49 is displayed. In the screen G43, the various settings already made can be modified.

Specifically, the operator has only to modify the relevant settings by the same operation as described above. After the modification, when the “OK” button is selected, the new settings for the image correction processing type to be modified are registered to replace the older settings. In other words, in the image server 130, the modified settings are reflected in the settings of the image correction processing type (steps S43c and S43d). Now, the modification of the image correction processing type is complete.

If the “cancel” button is selected instead, the operation for modifying the image correction processing type is aborted. In this case, in the image server 130, the settings before the modification are maintained, and the procedure returns to step S41 to wait for one of the buttons in the screen G4 to be selected.

An already-existing “image correction processing type” can be deleted by first selecting the “image correction processing type” to be deleted with a mouse and then selecting the “delete” button BT44. When, in the confirmation dialog box (not shown) appearing in response, the “OK” button is further selected, the image correction processing type selected to be deleted is actually deleted (step S44b). Now, the deletion of the image correction processing type is complete.

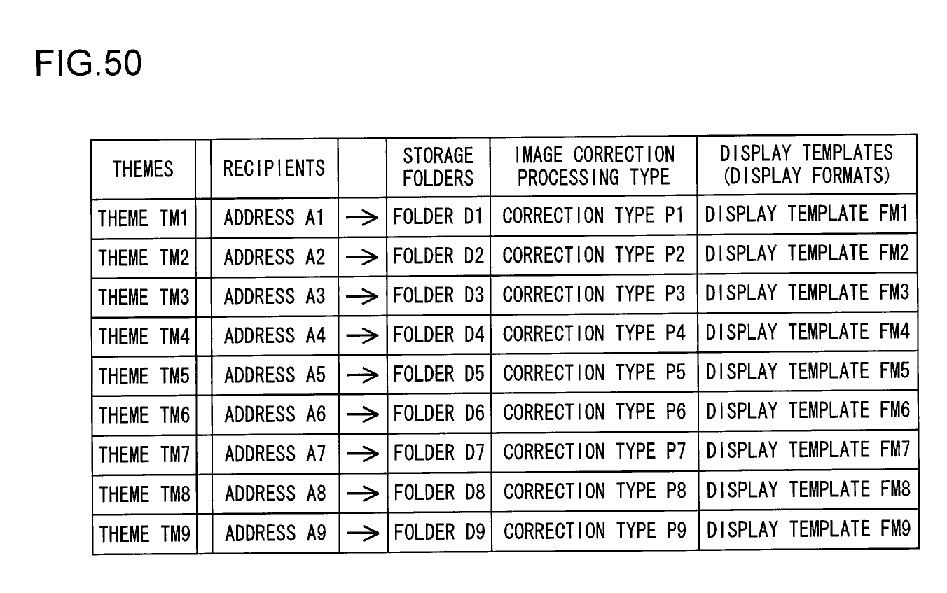

FIG. 50 is a diagram showing the correspondence among the individual themes, addresses, and other items. As shown in this figure, through the setting operations described above, the individual themes TM1 to TM9 can be assigned recipient mail addresses A1 to A9. Furthermore, the images included in mail sent to the individual recipient mail addresses A1 to A9 can be associated with “image storage folders” FD1 to FD9 specifying the folders in which to store the images, “display templates” FM1 to FM9 specifying the formats in which to display the images, and “image correction processing types” P1 to P9 specifying what image correction processing to perform on the images.

Specifically, the theme TM1 is associated with the recipient mail address A1, the display template FM1, and the image correction processing type P1. Likewise, the themes TM2 to TM9 are associated with the recipient mail addresses A2 to A9 etc.

When the setting operations described above are complete, the image server 130 can perform appropriate data processing on the images attached to mail sent from the digital cameras 110.

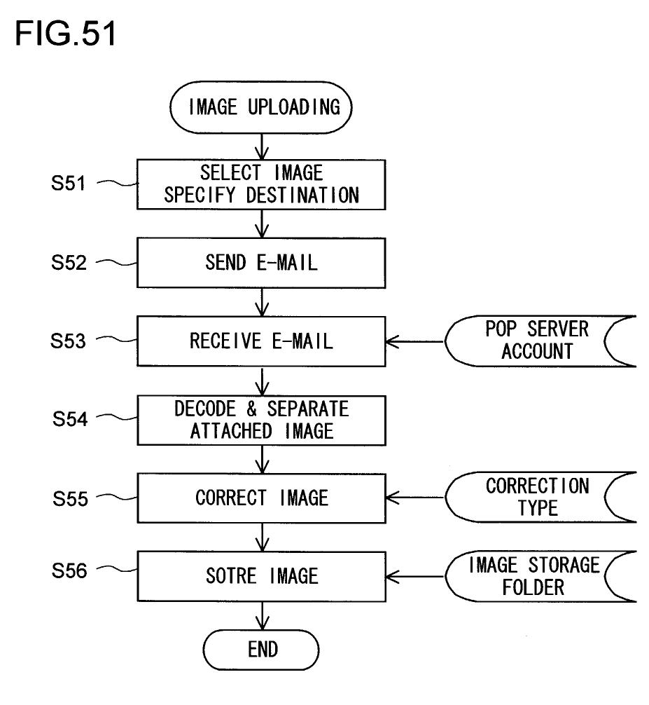

Next, the operation for the uploading of images such as photographed images from a digital camera 110 to the image server 130 and the operation related the data processing performed on the uploaded images on the image server 130 will be described. FIG. 51 is a flow chart showing these operations.

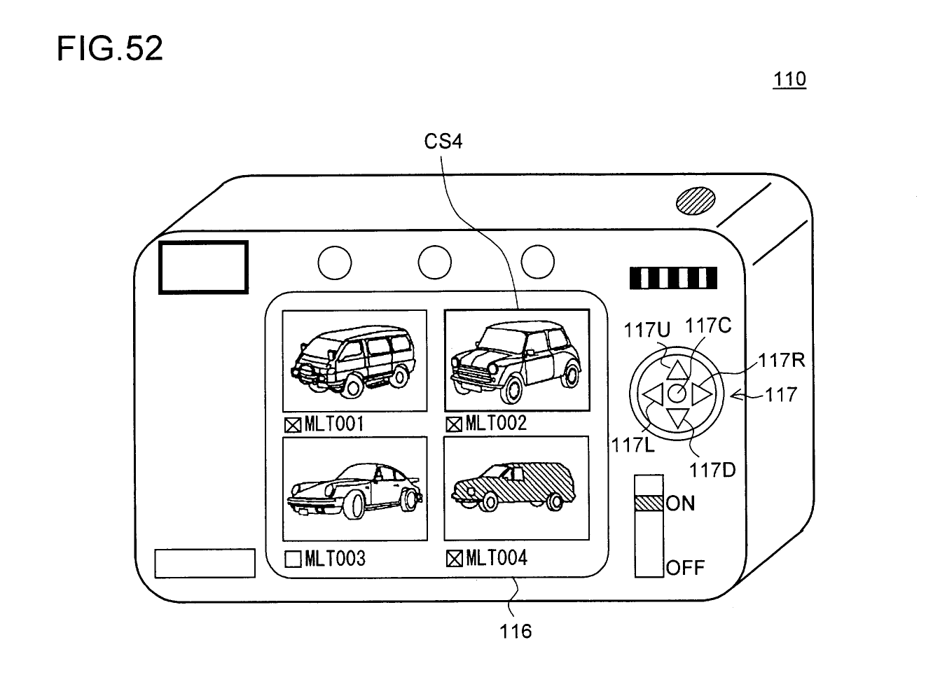

First, in step S51, the operator of the digital camera 110, through predetermined menu operation, calls the screen for transmitting images, and then selects, from among a plurality of images, images to be transmitted. Specifically, as shown in FIG. 52, with the digital camera 110 brought into a state in which a plurality of images are displayed in a display portion 116 on the back, the operator selects a desired images by operating a combination button 117 having arrow buttons 117U, 117D, 117L, and 117R for upward, downward, leftward, and rightward movement and a center button 117C.

More specifically, the operator moves a thick-frame cursor CS4 in desired directions by using the arrow buttons 117U, 117D, 117L, and 117R, and, when the thick-frame cursor CS4 comes on the image that he or she wants to transmit, selects the center button 117C. By this operation, the operator can select, as an image to be transmitted, the image pointed by the thick-frame cursor CS4.

When an image is selected, the corresponding check box is checked. By repeating similar operation, the operator can select a plurality of images. In this way, the display portion 116 and the combination button 117 function as a specifying means for specifying the recipient of an electronic message.

Then, the operator of the digital camera 110 specifies the destination address. Specifically, from among a plurality of destinations listed in an electronic address book stored in the digital camera 110, the operator specifies as the destination address an address having the theme appropriate for the images to be transmitted. Here, it is assumed that, through predetermined operation, mail addresses corresponding to various themes have previously been registered in the electronic address book stored in the digital camera 110.

Then, in step S52, the digital camera 110 creates electronic mail accompanied by the one or more images checked in the selection operation in step S51, and transmits the mail to the destination specified in step S51.

In step S53, the image server 130 checks the mail server 120 for mail. As a result, the mail transmitted from the digital camera 110 is received by the image server 130. In step S54, the image server 130 extracts and separates from the received mail the images (more precisely, image data) attached thereto.

In step S55, the image server 130 performs on the extracted images the image correction processing specified for the recipient address. The contents of the image correction processing performed here are as specified in the setting operations described earlier. More specifically, the image correction processing is performed according to the settings made to associate the “themes,” “recipient addresses,” and “image correction processing types” with one another in the screens G2 (see FIG. 38), G22 (see FIG. 40), G23 (FIG. 41), etc. in step S20 described earlier.

For example, if the data shown in FIG. 41 has been registered in the screen G23, image correction processing of the type named “Automobile, Indoors” is performed on the images received as addressed to the recipient address “buisness1@xxx.co.jp” corresponding to the theme “Motor Show.” The contents of the image correction processing type named “Automobile, Indoors” are as set in the screens G4 (see FIG. 36), G42 (see FIG. 38), etc. in step S40 described earlier.

In step S56, the images having been subjected to the image correction processing are stored in a predetermined image storage folder. The folder in which the images are stored here is the image storage folder as specified in the setting operations described earlier. More specifically, the image storage folder is determined according to the settings made to associate the “themes,” “recipient addresses,” and “image storage folders” with one another in the screens G2 (see FIG. 38), G22 (see FIG. 40), G23 (see FIG. 41), etc. in step S20 described earlier.

For example, if the data shown in FIG. 41 has been registered in the screen G23, the images received as addressed to the recipient address “buisness1@xxx.co.jp” corresponding to the theme “Motor Show” are stored in the folder “2001 Motor Show.”

As described above, in these upload and other operations, what data processing to perform on images has previously been determined on the image server 130. Thus, no settings are required on the digital camera 110. This helps reduce the burden of operation on the part of the digital camera 110, i.e., the sender.

Next, the operation for the viewing of uploaded images will be described. As described above, uploaded images are subjected to predetermined image correction processing and stored in predetermined storage folders according to the previously made settings. Here, how these stored images are viewed from a client computer 140 at a remote site will be described.

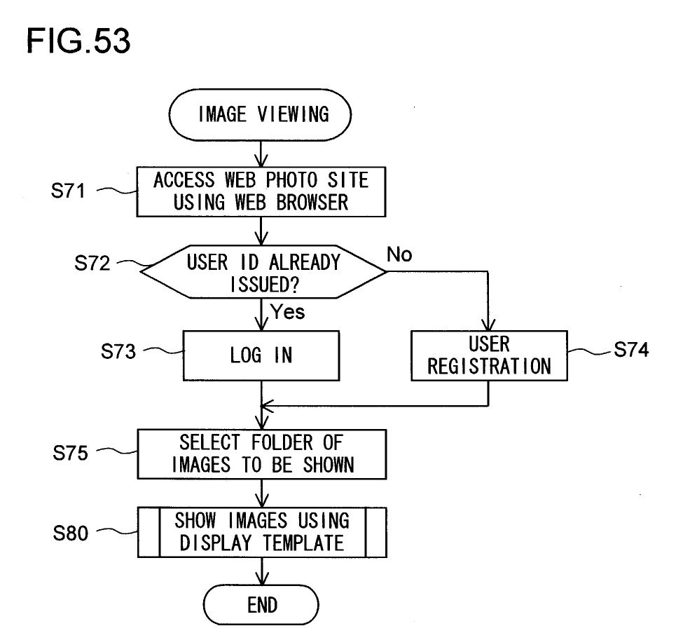

FIG. 53 is a flow chart showing this operation. First, in Step S71, the operator (user) of the client 140, by using a Web browser started on the client 140, accesses the image server 130 as the “Web photo site.” This causes the log-in screen G73, similar to the one shown in FIG. 7 described earlier, to be displayed on the display screen of the client 140.

In step S72, the user performs appropriate operation according to whether he or she has already acquired a user ID or not. Specifically, if the user already has completed user registration and acquired a user ID, he or she logs in by entering the user ID and a password (step S73).

On the other hand, if the user has not yet completed user registration, the procedure proceeds to step S74, where, in the screen G74 (see FIG. 8) for user registration, the user performs user registration. When the user enters predetermined items in the screen G74 and then selects the register button, user registration is complete. In this way, the user acquires a user ID and a password. After the completion of user registration, the user can log in.

In step S75, the user selects a theme about which he or she wants to view images. Specifically, in the screen G75 (see FIG. 9) appearing after log-in, the user selects the “image storage folder” associated with a desired theme. Here, the user is requested to select an “image storage folder.” However, it is also possible to request the user to select a “theme” directly. In that case, the image server 130, according to the settings made as descried earlier, shows the images in the image storage folder associated with the selected “theme.”

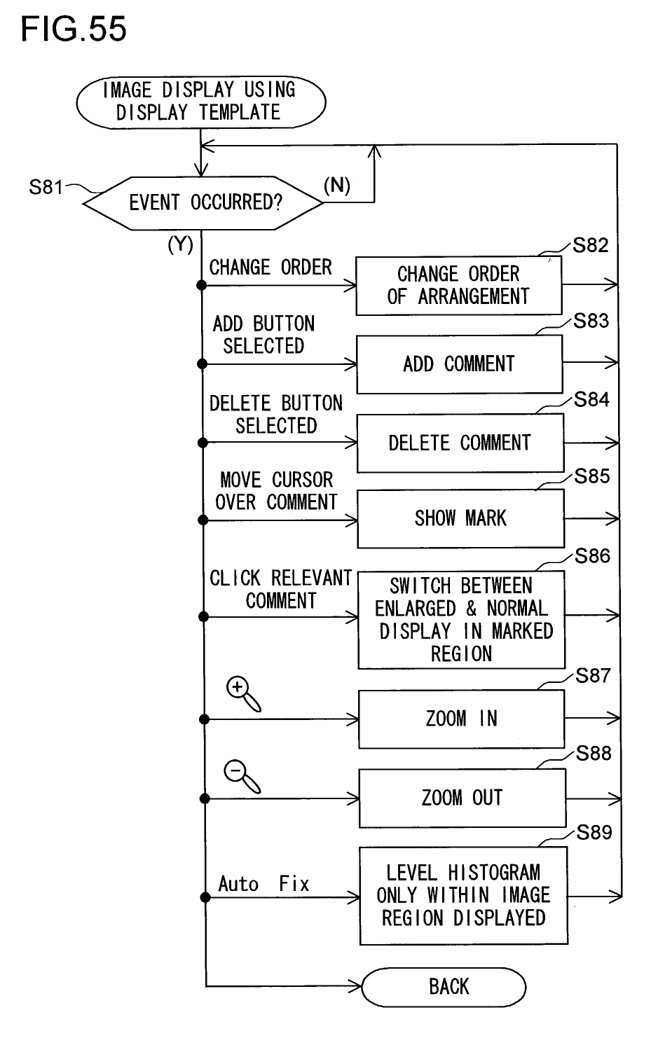

Then, in step S80, the procedure, shown in FIG. 55 and described later, for displaying images by using a display template is executed. Through this procedure, the image server 130 displays on the screen of the client 140 the images stored in the image storage folder specified in step S75. The display operation here is performed according to the “display template” associated with that “image storage folder.”

The following descriptions deal with a case where the image storage folder “2001 Motor Show” has been selected. In this case, the images stored in the image storage folder “2001 Motor Show” are displayed according to the display template associated with this image storage folder, namely “Exhibition Report.”

As described above, this association has previously been established in the operation performed in the screen G3 (see FIG. 42) in step S30 and the like described earlier. In the following descriptions, how the images are displayed will be described together with what this display template is.

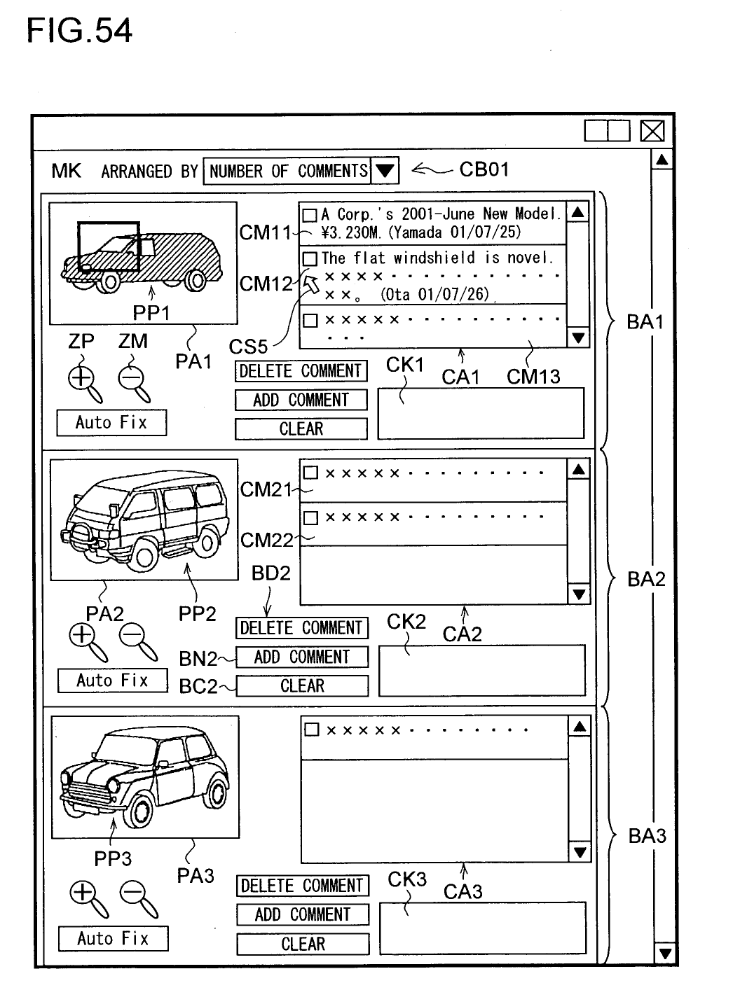

FIG. 54 is a diagram showing an example of how the images are displayed by using the display template named “Exhibition Report.” Such display is shown on the screen of a client 140. More specifically, in response to a request for display from the client 140 (step S75), the image server 130 outputs display data, i.e. what is to be displayed written in HTML, to the client 140, which functions as an HTML browser terminal.

That is, the image server 130 performs display output operation to display the images in a predetermined display format. Then, the client 140, by using the received display data, performs display operation in its own display portion. Here, the display data from the image server 130 is output over the network to a client 140 at a remote site. However, it is also possible, for example, to output the image data directly to the display portion of the image server 130 itself without transferring it over the network.

“Exhibition Report” is a display template that permits wide-ranging discussion and the like over images. This display template shows images in the form of an album, and is so configured as to permit entry of comments on each image shown. This permits image viewers to make comments and perform other operations on uploaded images.

In a left-hand portion of this display template are arranged image regions PA1, PA2, and PA3, and on the right of these image regions PA1, PA2, and PA3 are arranged comment regions CA1, CA2, and CA3, respectively. In the image regions PA1, PA2, and PA3 are shown images PP1, PP2, and PP3, respectively. In the comment regions CA1, CA2, and CA3 are shown comments on the images PP1, PP2, and PP3, respectively.

The unit region BA1, BA2, and BA3 allocated to the images PP1, PP2, and PP3, respectively, are arranged, from above, “by the number of comments,” i.e., in descending order of the number of comments made thereon.

More specifically, the topmost unit region BA1 is a display region relating to the image PP1, and includes the image region PA1 for the image PP1 and the comment region CA1 for the image PP1. Here, the comment region CA1 is located on the right of the image region PA1, and this makes the correspondence between the image and the comments clear. In the comment region CA1, there are shown up to three comments CM11, CM12, and CM13.

The unit region BA2 immediately below the unit region BA1 is a display region relating to the image PP2, and includes the image region PA2 for the image PP2 and the comment region CA2 for the image PP2. Here, the comment region CA2 is located on the right of the image region PA2, and this makes the correspondence between the image and the comments clear.

The unit region BA3 immediately below the unit region BA2 is configured in a similar manner, and this permits the user to clearly grasp the correspondence between the image and the comments clear.

FIG. 55 is a flow chart showing the procedure for displaying images by using a display template. Now, the operations performed in response to various events will be described, taking up as an example a case where the display template “Exhibition Report” described above is used. First, in step S81, the procedure waits for an event to occur.

When the combo box CB01 shown in an upper portion of FIG. 54 is operated, the procedure proceeds to step S82, where it changes the order in which the images are shown, i.e., rearranges the images. Specifically, a desired alternative can be selected from among a plurality of alternatives, such as “by the number of comments,” “by the date,” “by the name,” etc.. This permits the order in which the unit regions BA1, BA2, BA3, . . . are shown to be changed.

For example, if “by the date” is selected, the unit regions are shown in descending order of the date on which their respective image was uploaded, and if “by the name” is selected, the unit regions are shown in descending order of the file name of their respective image.

In the event waiting state, when the “add comment” button BN2 is selected, the procedure proceeds to step S83, where it permits a comment to be added to the image. Specifically, a newly received image has no comment added thereto yet. For example, to add a new comment to the image PP2, the operator first enters a comment he or she likes in the comment entry box CK2 by using a keyboard or the like.

On completion of the entry of the comment, the, operator selects the “add comment” button BN2. This causes the new comment to be added under the comment CM22 in the comment region CA2. If the operator selects the “clear” button BC2 instead, the characters entered in the comment entry box CK2 is cleared.

It is also possible, before adding the comment, to make a rectangular mark MK indicating a rectangular region of a desired size within the image PP2 with a drag of a mouse to specify a specified region. When the add comment button BN2 is selected after this operation, the comment is added together with the mark MK.

The mark MK is attached to the partial region highly relevant to the comment. That is, a mark serves as a “relevance indicator,” indicating that a partial region enclosed in a mark MK within the image region PA1, PA2, or the like is highly relevant to a particular comment. For example, a comment relevant to the roof portion of a car can be added with a mark MK left in the roof portion in the image on the left. As a result, the portion corresponding to the comment is indicated by the mark MK, which makes their correspondence clearer.

In the event waiting state, when the “delete comment” button BD2 is selected, the procedure proceeds to step S84, where it permits a comment to be deleted. Specifically, when the check box shown at the left-hand end of a comment (for example, CM1) to be deleted is selected and then the “delete comment” button BD2 is selected, any comment (for example, CM1) so cheeked in the comment display region CA1, CA2, and CS3 is deleted. Here, it is possible to delete a plurality of comments simultaneously by checking the check boxes of all those comments beforehand. It is advisable to additionally provide an access restricting means, as by requesting the operator to reconfirm the intention of comment deletion, to prevent erroneous operation.

In the event waiting state, when the mouse cursor is moved over the comment display region CA1, CA2, or CA3, the procedure proceeds to step S85. In step S85, the mark (here, MK12), i.e., the specified region, corresponding to the comment (here, CM12) over which the mouse cursor is moved is shown as a thick-line frame of a predetermined color (for example, white).

Here, the operation of moving the mouse cursor over a partial region within a comment region in which a particular comment is shown is called “mouse-over” operation. This mouse-over operation is one way of “comment selection,” i.e., operation for selecting a particular comment within a comment region.

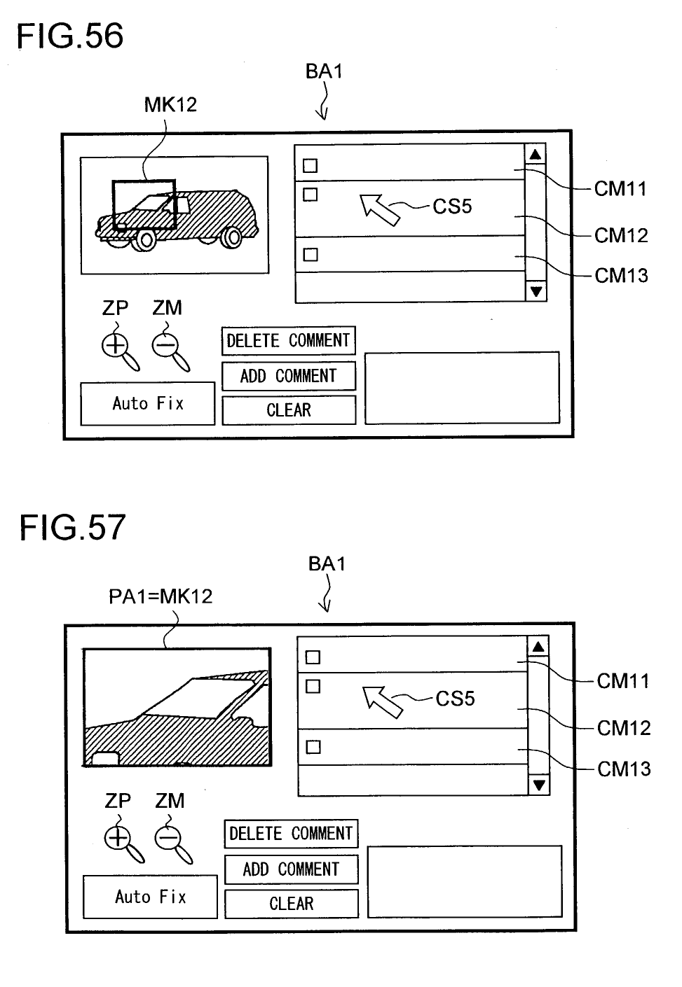

Here, a mark MK is shown only when the corresponding comment is being selected by mouse-over operation. This eliminates the need for an image viewer to click the mouse, and thus helps enhance operability. It is to be noted that, in FIG. 56, to make the drawing simple, only one BA1 of the plurality of unit regions is extracted and shown.

In the event waiting state, when a comment is clicked, the procedure proceeds to step S86, where it switches enlarged and normal display of the marked region. For example, in FIG. 56, when the comment CM12 is clicked with the mouse, the specified region corresponding to the comment CM12 and marked with the mark MK12 is displayed in an enlarged form over the entire area of the image region PA1. FIG. 57 shows this state with enlarged display. Enlarged display eases the viewing of the corresponding region. In the state shown in FIG. 57, when the same comment is clicked with the mouse again, the display returns to the sate shown in FIG. 56 without enlargement.

In the state in which the marked region is displayed with enlargement, when the “+” button ZP or the “−” button ZM is operated, the procedure proceeds to step S87 or S88, where it permits the magnification to be fine-adjusted. This makes it possible to display the region marked with the mark MK together with a portion surrounding it, or display only part of the region marked with the mark MK.

Moreover, it is possible to perform predetermined image processing on the partial region displayed with enlargement. Specifically, when the “auto fix” button is selected, the procedure proceeds to step S89. In step S89, the histogram of the image within the image region where enlarged display is shown is acquired, and leveling using the histogram is performed.

This makes it possible to perform appropriate image correction, and perform image correction special to that particular part. This is useful in a case where the image processing appropriate for a whole image is different from the image processing appropriate for part thereof.

For example, when a comparatively dim partial region within an image having appropriate brightness as a whole is displayed with enlargement, the partial region as it is may be too dim for easy viewing. In this case, by performing the operation described above, it is possible to perform correction processing on the enlarged region so as to increase the brightness thereof and thereby make it easier to view. In this way, it is possible to perform appropriate image processing in an enlarged partial region.

In the message processing system of this embodiment, on the basis of the processing performed by the image server 130, the billing portion 134 (see FIG. 33) bills users for charges for the provision of the message processing service. This makes it possible to bill users for charges according to the amount of data processed and the time spent for data processing.

Specifically, the image server 130 keeps a record of the amount of data of the image data and the time spent for image correction processing. On the basis of this record, the image server 130 performs the billing of service charges according to the amount of data of the image data stored, the time spent for image correction processing, and/or the like.

It is possible to bill those service users who have offered the service provider to register particular themes in the image server 130. It is also possible to bill those service users who have sent out messages in the form of mail having images attached thereto.

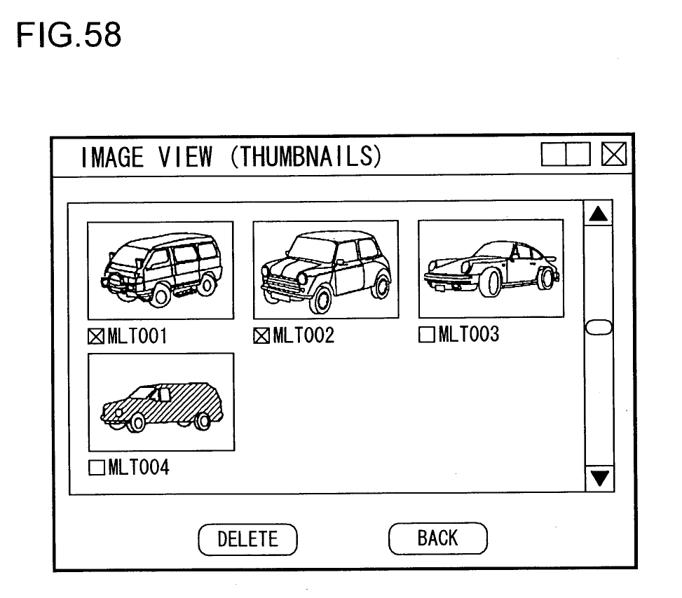

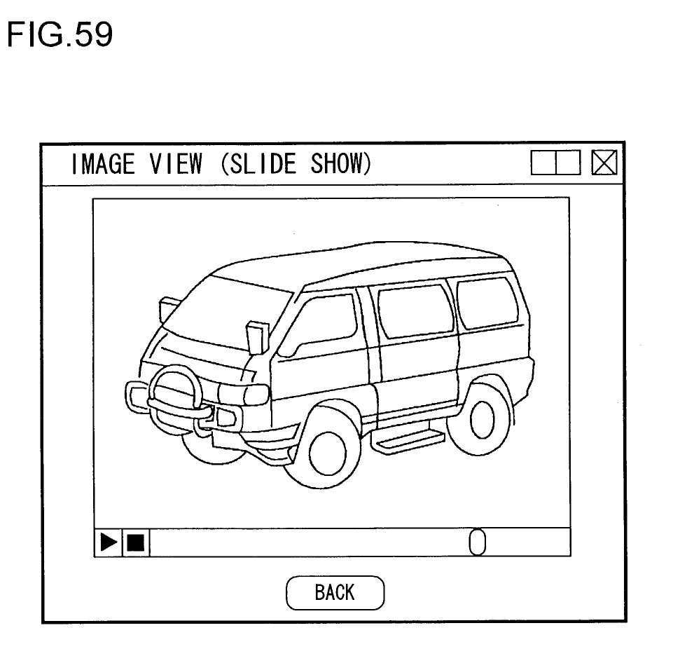

This embodiment deals with an example in which the display template shown in FIG. 54 is used. However, it is possible to use a display template configured in any other manner. For example, it is possible to use a display template that shows thumbnails (with a plurality of images shown in small size) as shown in FIG. 58. Alternatively, it is possible to use a display template that performs a slide show (with a plurality of images shown one after another) as shown in FIG. 59.

This embodiment deals with an example in which the present invention is applied to electronic mail (electronic messages) having still image data attached thereto. However, the present invention applies also to messages of any other type, for example, electronic messages having moving image data (including animation data) attached thereto.

In this embodiment, it is possible to handle not only image data (still or moving image data) but also sound data. That is, it is possible to handle multimedia data containing at least one of various kinds of data such as image data and sound data. Moreover, such multimedia data may be subjected to any kinds of data processing other than those specifically described above; for example, sound data may be subjected to noise reduction processing.

This embodiment deals with an example in which a client-server type electronic mail system using a mail server 120 or the like is used for electronic messaging. However, it is also possible to use any other type of electronic messaging. For example, it is possible to exchange electronic messages including images by pier-to-pier type communication such as instant messaging.

Here, the image server 130 is configured as a WWW server, but it may be configured as a server in a non-public (dedicated) network.

What is claimed is:

1. An image forming program for forming,
based on image data including a whole image, a specified region defining a part of the whole image, and character data corresponding to the specified region of the whole image,
an image having the character data arranged near to an extracted image extracting the specified region from the whole image.

2. An image forming program as claimed in claim 1,
wherein the extracted image is larger in size than the specified region as appearing when the whole image is output.

3. An image forming program as claimed in claim 1,
wherein, in the image formed,
a plurality of extracted images extracted from a plurality of specified regions are arranged in an array, and
the character data corresponding to the individual extracted images are arranged near to the respective individual extracted images.

4. An image forming program as claimed in claim 1,
wherein the whole image, the extracted image, and the character data can be displayed or printed simultaneously.

5. An image forming program for forming,
based on image data including a whole image, a specified region defining a part of the whole image, and character data corresponding to the specified region of the whole image,
an image composed of the character data and the whole image including the specified region,
wherein the character data is displayed with attributes variable according to attributes with which the corresponding specified region is displayed.

6. An image forming program as claimed in claim 5,
wherein the specified region is displayed with attributes identical with attributes with which the corresponding character data is displayed.

7. An image forming program as claimed in claim 5,
wherein a frame of the specified region has a same color as the character data.

8. An image forming program as claimed in claim 5,
wherein the character data corresponding to the specified region is arranged near to the specified region around the whole image.

9. An image forming program for forming an image based on image data including a whole image, a specified region defining a part of the whole image, and character data corresponding to the specified region of the whole image,
wherein, for particular character data, a plurality of specified regions defined in a plurality of whole images are displayed with the particular character data displayed together.

10. An image forming program as claimed in claim 9,
wherein display of the specified regions is achieved by indicating the specified regions within the whole images.

11. An image forming program as claimed in claim 9,
wherein display of the specified regions is achieved by displaying extracted images extracting the specified region from the whole image.

12. An image forming program as claimed in claim 9,
wherein images displaying the specified regions are arranged around the character data.

13. An image forming program for forming,
based on image data including a whole image, a specified region defining a part of the whole image, and character data corresponding to the specified region of the whole image,
an image composed of the whole image and the character data,
wherein an image extracting function is provided so that, when the character data is selected, an extracted image extracting the specified region from the whole image corresponding to the character data is displayed with enlargement.

14. An image forming program as claimed in claim 13,
wherein a pointing means for pointing a particular part on a display screen is provided so that, when the pointing means is moved into a region in which the character data is displayed, the specified region corresponding to the character data is displayed with enlargement.

15. An image forming program as claimed in claim 13,
wherein a zooming function for enlarging and reducing the extracted image is provided.

16. An image forming program as claimed in claim 15,
wherein a center of the extracted image coincides between before and after zooming.

17. An image processing apparatus comprising:
an image forming unit for forming, based on image data including a whole image, a specified region defining a part of the whole image, and character data corresponding to the specified region of the whole image, an image having the character data arranged near to an extracted image extracting the specified region from the whole image.

18. An image processing apparatus comprising:
an image forming unit for forming, based on image data including a whole image, a specified region defining a part of the whole image, and character data corresponding to the specified region of the whole image, an image composed of the character data and the whole image including the specified region,
wherein the character data is displayed with attributes variable according to attributes with which the corresponding specified region is displayed.

19. An image processing apparatus comprising:
an image forming unit for forming an image based on image data including a whole image, a specified region defining a part of the whole image, and character data corresponding to the specified region of the whole image,
wherein, for particular character data, a plurality of specified regions defined in a plurality of whole images are displayed with the particular character data displayed together.

20. An image processing apparatus comprising:
an image forming unit for forming, based on image data including a whole image, a specified region defining a part of the whole image, and character data corresponding to the specified region of the whole image, an image composed of the whole image and the character data,
wherein an image extracting function is provided so that, when the character data is selected, an extracted image extracting the specified region from the whole image corresponding to the character data is displayed with enlargement.
